(19) United States
(12) Patent Application Publication
(10) Pub. No.: US 2023/0152208 A1
(43) Pub. Date: May 18, 2023

(54) METHODS FOR DYNAMIC REAL-TIME ADJUSTMENT OF A DATA ACQUISITION PARAMETER IN A FLOW CYTOMETER

(71) Applicant: Becton, Dickinson and Company, Franklin Lakes, NJ (US)

(72) Inventors: Keegan Owsley, Campbell, CA (US); Christopher J. Wolf, San Jose, CA (US)

(21) Appl. No.: 17/984,931

(22) Filed: Nov. 10, 2022

Related U.S. Application Data
(60) Provisional application No. 63/280,373, filed on Nov. 17, 2021.

(51) Int. Cl. G01N 15/14

(52) U.S. Cl. CPC G01N 15/1475; G01N 15/147; G01N 2015/149

(57) ABSTRACT

Aspects of the present disclosure include methods for dynamic real-time adjustment of data acquisition parameters of a particle analyzer. Methods according to certain embodiments include detecting light from a particle of a sample in a flow stream irradiated with a light source, generating an image of the particle based on the detected light and automatically adjusting a data acquisition parameter of the particle analyzer in response to a modulated visualization parameter for the image of the particle. Systems (e.g., particle analyzers) having a light source and a light detection system that includes an imaging photodetector and processor with memory having instructions for practicing the subject methods are also described. Non-transitory computer readable storage medium is also provided.

### CROSS-REFERENCE TO RELATED APPLICATION

Pursuant to 35 U.S.C. § 119 (e), this application claims priority to the filing dates of U.S. Provisional Patent Application Ser. No. 63/280,373 filed Nov. 17, 2021, the disclosure of which application is incorporated herein by reference in their entirety.

### INTRODUCTION

Light detection is often used to characterize components of a sample (e.g., biological samples), for example when the sample is used in the diagnosis of a disease or medical condition. When a sample is irradiated, light can be scattered by the sample, transmitted through the sample as well as emitted by the sample (e.g., by fluorescence). Variations in the sample components, such as morphologies, absorptivity and the presence of fluorescent labels may cause variations in the light that is scattered, transmitted or emitted by the sample. These variations can be used for characterizing and identifying the presence of components in the sample. To quantify these variations, the light is collected and directed to the surface of a detector.

One technique that utilizes light detection to characterize the components in a sample is flow cytometry. A flow cytometer includes a photo-detection system made up of the optics, photodetectors and electronics that enable efficient detection of optical signals and its conversion to corresponding electric signals. The electronic signals are processed to obtain parameters that a user can utilize to perform desired analysis. A flow cytometer includes different types of photodetectors to detect a light signal, such as light signals from fluorescence, side scattered or front scattered light. When an optical signal is incident on the photodetectors, an electrical signal is produced at its output which is proportional to the incident optical signal. Cytometers further include means for recording and analyzing the measured data. For example, data storage and analysis may be carried out using a computer connected to the detection electronics. The data can be stored in tabular form, where each row corresponds to data for one particle, and the columns correspond to each of the measured parameters. Analysis methods are generally in 2-dimensional (2D) dot plots for ease of visualization of a population of particles.

Parameters of the particle analyzer such as photodetector signal-to-noise and event detection thresholds are typically calibrated using a set of standard compounds, for example fluorescent beads. These calibration parameters can be used for setting threshold sensitivity of the light detection system as well as for use in determining sorting gates for particles of an irradiated sample.

### SUMMARY

Aspects of the present disclosure include methods for dynamic real-time adjustment of data acquisition parameters of a particle analyzer. Methods according to certain embodiments include detecting light from a particle of a sample in a flow stream irradiated with a light source, generating an image of the particle based on the detected light and automatically adjusting a data acquisition parameter of the particle analyzer in response to a modulated visualization parameter for the image of the particle. Systems (e.g., particle analyzers) having a light source and a light detection system that includes an imaging photodetector and processor with memory having instructions for practicing the subject methods are also described. Non-transitory computer readable storage medium is also provided.

In practicing the subject methods, light from a particle of sample in a flow stream is detected and one or more images (e.g., frequency-encoded images) of the particle is generated based on the detected light. In some embodiments, methods include detecting one or more of light absorption, light scatter, light emission (e.g., fluorescence) from the sample in the flow stream. In some instances, an image of one or more particles in the sample is generated from data signals from a scattered light detector channel (e.g., forward scatter image data, side scatter image data). In yet other instances, an image of one or more particles in the sample are generated from data signals from one or more fluorescence detector channels (e.g., fluorescent marker image data). In other instances, an image of one or more particles in the sample is generated from data signals from a light loss detector channel. In still other instances, an image of one or more particles in the sample is generated from a combination of data signals from two or more of light scatter detector channels, fluorescence detector channels and light loss detector channels.

In some embodiments, methods include modulating a visualization parameter of the image. In some instances, the visualization parameter is modulated for a region of analysis of the image. In some instances, the visualization parameter modulated in the region of analysis is a visualization threshold for the particle in the image. In certain instances, methods include modulating the visualization parameter in the region of analysis sufficient to visualize a border of the particle in the image. In some instances, methods include modulating the visualization parameter in the region of analysis sufficient to visualize an interior component of the particle in the image. In some instances, methods include modulating the visualization parameter in the region of analysis sufficient to visualize a sub-cellular component of a cell in the image. In some embodiments, visualization parameters of two or more particle images are modulated simultaneously.

In some instances, the modulated visualization parameter is a pixel intensity threshold. In certain instances, the pixel intensity threshold is modulated for one or more detector channels, such as for example modulated for one or more of a forward scattered light detector channel, a side scattered light detector channel, a fluorescence detector channel and a light loss detector channel. In certain instances, the pixel intensity threshold is modulated for a scattered light detector channel (e.g., side-scatter or forward-scatter) and a fluorescence light detector channel. In other instances, the pixel intensity threshold is modulated for a scattered light detector channel and two or more fluorescence light detector channels, such as three or more and including 6 or more fluorescence detector channels. In certain instances, the detection parameter is a threshold for light intensity at each pixel location in the region of analysis. In some instances, the visualization parameter is adjusted on a graphical user interface. In certain instances, modulating the visualization parameter includes adjusting a threshold (e.g., a pixel intensity threshold) with a slide bar on the graphical user interface. In some embodiments, methods include modulating the visualization parameters of two or more particle images simultaneously by adjusting the slide bar on the graphical user interface.

In embodiments, methods include automatically adjusting a data acquisition parameter of the particle analyzer in response to a change in the visualization parameter for the particle image. In some embodiments, the data acquisition parameters of the particle analyzer are automatically adjusted while light from the irradiated sample in the flow stream is being detected. In some instances, a light intensity detection threshold for one or more of the detector channels (e.g., side-scattered light, fluorescence light) is dynamically adjusted in real time in response to a change in the visualization parameter. In some embodiments, the methods include applying the change to the data acquisition parameter to data signals generated in one or more non-imaging photodetector channels of the light detection system.

In some embodiments, the data acquisition parameter is a light intensity detection threshold for generating an image. In some instances, an image of the particle is generated when light detected in one or more of the detection channels (e.g., a side scattered light detection channel) exceeds the adjusted light intensity detection threshold. In other instances, an image of the particle is not generated when light detected in a light detection channel does not exceed the light intensity threshold. In some instances, a sorting parameter for the particle analyzer is automatically adjusted in response to a change in the visualization parameter. In certain instances, methods include dynamically adjusting in real time a sorting gate for one or more particle populations in the sample in response to a change in a visualization parameter for a particle image. In certain instances, a digital signal processing parameter of an integrated circuit device (e.g., a field programmable gate array) operationally coupled to the particle analyzer is automatically adjusted in response to the modulated visualization parameter.

Aspects of the present disclosure also include systems (e.g., particle analyzer) having a light detection system that includes an imaging photodetector. In embodiments, the light detection system is configured to detect light from particles of a sample in a flow stream irradiated with a light source (e.g., a laser) and a processor having memory operably coupled to the processor where the memory includes instructions stored thereon, which when executed by the processor, cause the processor to generate an image of each particle based on the detected light, modulate a visualization parameter for the image of a particle in the flow stream and automatically adjust a data acquisition parameter of the system in response to the modulated visualization parameter. In some embodiments, the system is a particle analyzer. In certain instances, the particle analyzer is incorporated into a flow cytometer, such as where the flow cytometer is configured to visualize and sort one or more particles in the flow stream. In certain instances, the system includes one or more integrated circuits such as an FPGA.

In some embodiments, the system includes memory with instructions for generating an image of a particle, such as one or more frequency-encoded images of the particle based on data signals from the light detection system. In embodiments, systems may include light scatter photodetectors, fluorescence light photodetectors and light loss photodetectors. In some instances, the system is configured to generate the image of the particle based on data signals from scattered light detector channels (e.g., forward scatter image data, side scatter image data). In other instances, the system is configured to generate the image of the particle based on data signals from one or more fluorescence detector channels. In other instances, the system is configured to generate the image of the particle based on data signals from one or more light loss detector channels. In still other instances, the system is configured to generate the image of the particle based on data signals from a combination of data signals from two or more of light scatter detector channels, fluorescence detector channels and light loss detector channels.

In some instances, systems include memory with instructions for modulating a visualization parameter of the image. In some instances, the memory includes instructions for modulating the visualization parameter for a region of analysis of the image. In some instances, the memory includes instructions for modulating a visualization threshold for the particle in the image. In certain instances, the memory includes instructions for modulating the visualization parameter in the region of analysis sufficient to visualize a border of the particle in the image. In some instances, the memory includes instructions for modulating the visualization parameter in the region of analysis sufficient to visualize an interior component of the particle in the image. In some instances, the memory includes instructions for modulating the visualization parameter in the region of analysis sufficient to visualize a sub-cellular component of a cell in the image. In some embodiments, the memory includes instructions for modulating visualization parameters of two or more particle images are modulated simultaneously.

In some instances, the modulated visualization parameter is a pixel intensity threshold. In certain instances, the system includes memory having instructions stored thereon to modulate the pixel intensity threshold for one or more detector channels. In some embodiments, the memory includes instructions for modulating the pixel intensity threshold for a scattered light detector channel (e.g., side-scatter or forward-scatter) and a fluorescence light detector channel. In other instances, the memory includes instructions for modulating the pixel intensity threshold for a scattered light detector channel and two or more fluorescence light detector channel. In certain instances, the detection parameter is a threshold for light intensity at each pixel location in the region of analysis. In some instances, the system includes a display with a graphical interface for adjusting the visualization parameter. In certain instances, the graphical user interface includes a slide bar for adjusting a threshold (e.g., a pixel intensity threshold). In some embodiments, the graphical user interface is configured to modulate the visualization parameters of two or more particle images simultaneously by adjusting the slide bar (e.g., sliding the slide bar on the graphical user interface across a horizontal axis or a vertical axis).

In embodiments, systems of interest are configured to automatically adjust a data acquisition parameter (e.g., of the particle analyzer or particle sorter) in response to a change in the visualization parameter for the particle image. In some embodiments, the memory includes instructions for automatically adjusting data acquisition parameters of the particle analyzer while light from the irradiated sample in the flow stream is being detected. In some instances, the memory includes instructions for dynamically adjusting a light intensity detection threshold for one or more of the detector channels (e.g., side-scattered light, fluorescence light) in real time in response to a change in the visualization parameter. In some embodiments, the memory includes instructions for applying the change to the data acquisition parameter to data signals generated in one or more non-imaging photodetector channels of the light detection system.

In some embodiments, the data acquisition parameter is a light intensity detection threshold for generating an image. In some instances, the memory includes instructions for generating an image of the particle when light detected in one or more of the detection channels (e.g., a side scattered light detection channel) exceeds the adjusted light intensity detection threshold. In other instances, the memory includes instructions for not generating an image of the particle when light detected in a light detection channel does not exceed the light intensity threshold. In some instances, the memory includes instructions for automatically adjusting a sorting parameter for the particle analyzer in response to a change in the visualization parameter. In certain instances, the memory includes instructions for dynamically adjusting in real time a sorting gate for one or more particle populations in the sample in response to a change in a visualization parameter for a particle image. In certain instances, a digital signal processing parameter of an integrated circuit device (e.g., a field programmable gate array) operationally coupled to the particle analyzer is automatically adjusted in response to the modulated visualization parameter.

Aspects of the present disclosure also include non-transitory computer readable storage medium for dynamically adjusting in real time a data acquisition parameter of a particle analyzer. In embodiments, the non-transitory computer readable storage medium includes algorithm for detecting light from a particle of a sample in a flow stream irradiated with a light source, algorithm for generating an image of each particle based on the detected light and algorithm for automatically adjusting a data acquisition parameter of the particle analyzer in response to a modulated visualization parameter for the image of the particle. In some embodiments, the non-transitory computer readable storage medium includes algorithm for generating an image of a particle, such as one or more frequency-encoded images of the particle based on data signals from the light detection system. In some instances, the non-transitory computer readable storage medium includes algorithm for generating the image of the particle based on data signals from scattered light detector channels (e.g., forward scatter image data, side scatter image data). In other instances, the non-transitory computer readable storage medium includes algorithm for generating the image of the particle based on data signals from one or more fluorescence detector channels. In other instances, the non-transitory computer readable storage medium includes algorithm for generating the image of the particle based on data signals from one or more light loss detector channels. In still other instances, the non-transitory computer readable storage medium includes algorithm for generating the image of the particle based on data signals from a combination of data signals from two or more of light scatter detector channels, fluorescence detector channels and light loss detector channels.

In some instances, the non-transitory computer readable storage medium includes algorithm for modulating a visualization parameter of the image. In some instances, the non-transitory computer readable storage medium includes algorithm for modulating the visualization parameter for a region of analysis of the image. In some instances, the non-transitory computer readable storage medium includes algorithm for modulating a visualization threshold for the particle in the image. In certain instances, the non-transitory computer readable storage medium includes algorithm for modulating the visualization parameter in the region of analysis sufficient to visualize a border of the particle in the image. In some instances, the non-transitory computer readable storage medium includes algorithm for modulating the visualization parameter in the region of analysis sufficient to visualize an interior component of the particle in the image. In some instances, the non-transitory computer readable storage medium includes algorithm for modulating the visualization parameter in the region of analysis sufficient to visualize a sub-cellular component of a cell in the image. In some embodiments, the non-transitory computer readable storage medium includes algorithm for modulating visualization parameters of two or more particle images are modulated simultaneously.

In some instances, the non-transitory computer readable storage medium includes algorithm for modulating a pixel intensity threshold. In certain instances, the non-transitory computer readable storage medium includes algorithm for modulating the pixel intensity threshold for one or more detector channels. In some embodiments, the non-transitory computer readable storage medium includes algorithm for modulating the pixel intensity threshold for a scattered light detector channel (e.g., side-scatter or forward-scatter) and a fluorescence light detector channel. In other instances, the non-transitory computer readable storage medium includes algorithm for modulating the pixel intensity threshold for a scattered light detector channel and two or more fluorescence light detector channel. In certain instances, the detection parameter is a threshold for light intensity at each pixel location in the region of analysis.

In embodiments, the non-transitory computer readable storage medium includes algorithm for automatically adjusting a data acquisition parameter (e.g., of the particle analyzer or particle sorter) in response to a change in the visualization parameter for the particle image. In some embodiments, the non-transitory computer readable storage medium includes algorithm for automatically adjusting data acquisition parameters of the particle analyzer while light from the irradiated sample in the flow stream is being detected. In some instances, the non-transitory computer readable storage medium includes algorithm for dynamically adjusting a light intensity detection threshold for one or more of the detector channels (e.g., side-scattered light, fluorescence light) in real time in response to a change in the visualization parameter. In some embodiments, the non-transitory computer readable storage medium includes algorithm for applying the change to the data acquisition parameter to data signals generated in one or more non-imaging photodetector channels of the light detection system.

In some embodiments, the data acquisition parameter is a light intensity detection threshold for generating an image. In some instances, the non-transitory computer readable storage medium includes algorithm for generating an image of the particle when light detected in one or more of the detection channels (e.g., a side scattered light detection channel) exceeds the adjusted light intensity detection threshold. In other instances, the non-transitory computer readable storage medium includes algorithm for not generating an image of the particle when light detected in a light detection channel does not exceed the light intensity threshold. In some instances, the non-transitory computer readable storage medium includes algorithm for automatically adjusting a sorting parameter for the particle analyzer in response to a change in the visualization parameter. In certain instances, the non-transitory computer readable storage medium includes algorithm for dynamically adjusting in real time a sorting gate for one or more particle populations in the sample in response to a change in a visualization parameter for a particle image.

### BRIEF DESCRIPTION OF THE FIGURES

The invention may be best understood from the following detailed description when read in conjunction with the accompanying drawings. Included in the drawings are the following figures:

FIG. 1 depicts images of a particle for modulating a visualization parameter according to certain embodiments.

FIG. 2 depicts modulating a visualization parameter of particle images according to certain embodiments.

FIG. 3A depicts a flow chart for dynamic real-time adjustment of a data acquisition parameter of a particle analyzer according to certain embodiments.

FIG. 3B depicts a flow chart for dynamically adjusting a firmware parameter during data acquisition for a particle analyzer according to certain embodiments.

FIG. 4A depicts a functional block diagram of a particle analysis system according to certain embodiments. FIG. 4B depicts a flow cytometer according to certain embodiments.

FIG. 5 depicts a functional block diagram for one example of a particle analyzer control system according to certain embodiments.

FIG. 6A depicts a schematic drawing of a particle sorter system according to certain embodiments.

FIG. 6B depicts a schematic drawing of a particle sorter system according to certain embodiments.

FIG. 7 depicts a block diagram of a computing system according to certain embodiments.

### DETAILED DESCRIPTION

Aspects of the present disclosure include methods for dynamic real-time adjustment of data acquisition parameters of a particle analyzer. Methods according to certain embodiments include detecting light from a particle of a sample in a flow stream irradiated with a light source, generating an image of the particle based on the detected light and automatically adjusting a data acquisition parameter of the particle analyzer in response to a modulated visualization parameter for the image of the particle. Systems (e.g., particle analyzers) having a light source and a light detection system that includes an imaging photodetector and processor with memory having instructions for practicing the subject methods are also described. Non-transitory computer readable storage medium is also provided.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

While the apparatus and method has or will be described for the sake of grammatical fluidity with functional explanations, it is to be expressly understood that the claims, unless expressly formulated under 35 U.S.C. § 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 U.S.C. § 112 are to be accorded full statutory equivalents under 35 U.S.C. § 112.

As summarized above, the present disclosure provides methods for dynamic real-time adjustment of data acquisition parameters of a particle analyzer. In further describing embodiments of the disclosure, methods for detecting light from a particle of a sample in a flow stream, generating an image of the particle based on the light from one or more detector channels and automatically adjusting a data acquisition parameter of the particle analyzer in response to a modulated visualization parameter for the image of the particle are first described in greater detail. Next, systems that include a light source and a light detection system having one or more photodetectors and non-transitory computer readable storage medium and integrated circuits for practicing the subject methods are described.

### Methods for Dynamic Real-Time Adjustment of Data Acquisition Parameters of a Particle Analyzer

Aspects of the present disclosure include methods for dynamic real-time adjustment of data acquisition parameters of a particle analyzer. In some instances, methods provide for automatic adjustments to the particle analyzer which improve accuracy in measuring cell-image characteristics. For example, dynamic adjustments to data acquisition parameters of the particle analyzers provide for increased precision in determining the size of particles in the sample, the center of mass or the eccentricity of particles along a horizontal or vertical axis. In certain instances, adjusting data acquisition parameters of the particle analyzer minimizes or altogether eliminates photodetector signal noise, such as where photodetector signal noise is reduced by 5% or more, such as by 10% or more, such as by 25% or more, such as by 50% or more, such as by 75% or more, such as by 90% or more and including by 99% or more. In certain embodiments, the subject methods provide for an increased signal-to-noise ratio of the light detection system, such as where the signal-to-noise ratio of the light detection system is increased by 5% or more, such as by 10% or more, such as by 25% or more, such as by 50% or more, such as by 75% or more, such as by 90% or more and including by 99% or more. In certain instances, the subject methods increase the signal-to-noise ratio by 2-fold or more, such as by 3-fold or more, such as by 4-fold or more, such as by 5-fold or more and including by 10-fold or more. In certain embodiments, methods of the present disclosure are sufficient to broaden the range of intensity detection and quantitation by 2-fold or greater, such as by 3-fold or greater, such as by 5-fold or greater, such as by 10-fold or greater, such as by 25-fold or greater, such as by 50-fold or greater and including by 100-fold or greater. In other instances, the dynamic adjustments to the data acquisition parameters of the particle analyzer are sufficient to reduce or eliminate photodetector signal intensity variation, such as where photodetector signal intensity varies by 5% or less, such as by 4% or less, such as by 3% or less, such as by 2% or less, such as by 1% or less, such as by 0.5% or less, such as by 0.1% or less, such as by 0.05% or less, such as by 0.01% or less, such as by 0.005% or less and including where dynamic adjustments to the data acquisition parameters of the particle analyzer are sufficient to reduce or eliminate photodetector signal intensity variation by 0.001% or less.

In practicing the subject methods, light is detected from a particle of a sample in a flow stream irradiated with a light source. In some embodiments, methods include irradiating a particle propagating through the flow stream across an interrogation region of the flow stream of 5 μm or more, such as 10 μm or more, such as 15 μm or more, such as 20 μm or more, such as 25 μm or more, such as 50 μm or more, such as 75 μm or more, such as 100 μm or more, such as 250 μm or more, such as 500 μm or more, such as 750 μm or more, such as for example across an interrogation region of 1 mm or more, such as 2 mm or more, such as 3 mm or more, such as 4 mm or more, such as 5 mm or more, such as 6 mm or more, such as 7 mm or more, such as 8 mm or more, such as 9 mm or more and including 10 mm or more.

In some embodiments, the methods include irradiating the particle in the flow stream with a continuous wave light source, such as where the light source provides uninterrupted light flux and maintains irradiation of particles in the flow stream with little to no undesired changes in light intensity. In some embodiments, the continuous light source emits non-pulsed or non-stroboscopic irradiation. In certain embodiments, the continuous light source provides for substantially constant emitted light intensity. For instance, methods may include irradiating the particle in the flow stream with a continuous light source that provides for emitted light intensity during a time interval of irradiation that varies by 10% or less, such as by 9% or less, such as by 8% or less, such as by 7% or less, such as by 6% or less, such as by 5% or less, such as by 4% or less, such as by 3% or less, such as by 2% or less, such as by 1% or less, such as by 0.5% or less, such as by 0.1% or less, such as by 0.01% or less, such as by 0.001% or less, such as by 0.0001% or less, such as by 0.00001% or less and including where the emitted light intensity during a time interval of irradiation varies by 0.000001% or less. The intensity of light output can be measured with any convenient protocol, including but not limited to, a scanning slit profiler, a charge coupled device (CCD, such as an intensified charge coupled device, ICCD), a positioning sensor, power sensor (e.g., a thermopile power sensor), optical power sensor, energy meter, digital laser photometer, a laser diode detector, among other types of photodetectors.

In other embodiments, the methods include irradiating the particle propagating through the flow stream with a pulsed light source, such as where light is emitted at predetermined time intervals, each time interval having a predetermined irradiation duration (i.e., pulse width). In certain embodiments, methods include irradiating the particle with the pulsed light source in each interrogation region of the flow stream with periodic flashes of light. For example, the frequency of each light pulse may be 0.0001 kHz or greater, such as 0.0005 kHz or greater, such as 0.001 kHz or greater, such as 0.005 kHz or greater, such as 0.01 kHz or greater, such as 0.05 kHz or greater, such as 0.1 kHz or greater, such as 0.5 kHz or greater, such as 1 kHz or greater, such as 2.5 kHz or greater, such as 5 kHz or greater, such as 10 kHz or greater, such as 25 kHz or greater, such as 50 kHz or greater and including 100 kHz or greater. In certain instances, the frequency of pulsed irradiation by the light source ranges from 0.00001 kHz to 1000 kHz, such as from 0.00005 kHz to 900 kHz, such as from 0.0001 kHz to 800 kHz, such as from 0.0005 kHz to 700 kHz, such as from 0.001 kHz to 600 kHz, such as from 0.005 kHz to 500 kHz, such as from 0.01 kHz to 400 kHz, such as from 0.05 kHz to 300 kHz, such as from 0.1 kHz to 200 kHz and including from 1 kHz to 100 kHz. The duration of light irradiation for each light pulse (i.e., pulse width) may vary and may be 0.000001 ms or more, such as 0.000005 ms or more, such as 0.00001 ms or more, such as 0.00005 ms or more, such as 0.0001 ms or more, such as 0.0005 ms or more, such as 0.001 ms or more, such as 0.005 ms or more, such as 0.01 ms or more, such as 0.05 ms or more, such as 0.1 ms or more, such as 0.5 ms or more, such as 1 ms or more, such as 2 ms or more, such as 3 ms or more, such as 4 ms or more, such as 5 ms or more, such as 10 ms or more, such as 25 ms or more, such as 50 ms or more, such as 100 ms or more and including 500 ms or more. For example, the duration of light irradiation may range from 0.000001 ms to 1000 ms, such as from 0.000005 ms to 950 ms, such as from 0.00001 ms to 900 ms, such as from 0.00005 ms to 850 ms, such as from 0.0001 ms to 800 ms, such as from 0.0005 ms to 750 ms, such as from 0.001 ms to 700 ms, such as from 0.005 ms to 650 ms, such as from 0.01 ms to 600 ms, such as from 0.05 ms to 550 ms, such as from 0.1 ms to 500 ms, such as from 0.5 ms to 450 ms, such as from 1 ms to 400 ms, such as from 5 ms to 350 ms and including from 10 ms to 300 ms.

The flow stream may be irradiated with any convenient light source and may include laser and non-laser light sources (e.g., light emitting diodes). In certain embodiments, methods include irradiating the particle with a laser, such as a pulsed or continuous wave laser. For example, the laser may be a diode laser, such as an ultraviolet diode laser, a visible diode laser and a near-infrared diode laser. In other embodiments, the laser may be a helium-neon (HeNe) laser. In some instances, the laser is a gas laser, such as a helium-neon laser, argon laser, krypton laser, xenon laser, nitrogen laser, CO₂ laser, CO laser, argon-fluorine (ArF) excimer laser, krypton-fluorine (KrF) excimer laser, xenon chlorine (XeCl) excimer laser or xenon-fluorine (XeF) excimer laser or a combination thereof. In other instances, the subject systems include a dye laser, such as a stilbene, coumarin or rhodamine laser. In yet other instances, lasers of interest include a metal-vapor laser, such as a helium-cadmium (HeCd) laser, helium-mercury (HeHg) laser, helium-selenium (HeSe) laser, helium-silver (HeAg) laser, strontium laser, neon-copper (NeCu) laser, copper laser or gold laser and combinations thereof. In still other instances, the subject systems include a solid-state laser, such as a ruby laser, an Nd:YAG laser, NdCrYAG laser, Er:YAG laser, Nd:YLF laser, Nd:YVO₄ laser, Nd:YCa₄O(BO₃)₃ laser, Nd:YCOB laser, titanium sapphire laser, thulim YAG laser, ytterbium YAG laser, ytterbium₂O₃ laser or cerium doped lasers and combinations thereof.

In some embodiments, the light source outputs a specific wavelength such as from 200 nm to 1500 nm, such as from 250 nm to 1250 nm, such as from 300 nm to 1000 nm, such as from 350 nm to 900 nm and including from 400 nm to 800 nm. In certain embodiments, the continuous wave light source emits light having a wavelength of 365 nm, 385 nm, 405 nm, 460 nm, 490 nm, 525 nm, 550 nm, 580 nm, 635 nm, 660 nm, 740 nm, 770 nm or 850 nm.

The flow stream may be irradiated by the light source from any suitable distance, such as at a distance of 0.001 mm or more, such as 0.005 mm or more, such as 0.01 mm or more, such as 0.05 mm or more, such as 0.1 mm or more, such as 0.5 mm or more, such as 1 mm or more, such as 5 mm or more, such as 10 mm or more, such as 25 mm or more and including at a distance of 100 mm or more. In addition, irradiation of the flow stream may be at any suitable angle such as at an angle ranging from 10° to 90°, such as from 15° to 85°, such as from 20° to 80°, such as from 25° to 75° and including from 30° to 60°, for example at a 90° angle.

In some embodiments, methods include further adjusting the light from the sample before detecting the light. For example, the light from the sample source may be passed through one or more lenses, mirrors, pinholes, slits, gratings, light refractors, and any combination thereof. In some instances, the collected light is passed through one or more focusing lenses, such as to reduce the profile of the light. In other instances, the emitted light from the sample is passed through one or more collimators to reduce light beam divergence.

In certain embodiments, methods include irradiating the sample with two or more beams of frequency shifted light. As described above, a light beam generator component may be employed having a laser and an acousto-optic device for frequency shifting the laser light. In these embodiments, methods include irradiating the acousto-optic device with the laser. Depending on the desired wavelengths of light produced in the output laser beam (e.g., for use in irradiating a sample in a flow stream), the laser may have a specific wavelength that varies from 200 nm to 1500 nm, such as from 250 nm to 1250 nm, such as from 300 nm to 1000 nm, such as from 350 nm to 900 nm and including from 400 nm to 800 nm. The acousto-optic device may be irradiated with one or more lasers, such as 2 or more lasers, such as 3 or more lasers, such as 4 or more lasers, such as 5 or more lasers and including 10 or more lasers. The lasers may include any combination of types of lasers. For example, in some embodiments, the methods include irradiating the acousto-optic device with an array of lasers, such as an array having one or more gas lasers, one or more dye lasers and one or more solid-state lasers.

Where more than one laser is employed, the acousto-optic device may be irradiated with the lasers simultaneously or sequentially, or a combination thereof. For example, the acousto-optic device may be simultaneously irradiated with each of the lasers. In other embodiments, the acousto-optic device is sequentially irradiated with each of the lasers. Where more than one laser is employed to irradiate the acousto-optic device sequentially, the time each laser irradiates the acousto-optic device may independently be 0.001 microseconds or more, such as 0.01 microseconds or more, such as 0.1 microseconds or more, such as 1 microsecond or more, such as 5 microseconds or more, such as 10 microseconds or more, such as 30 microseconds or more and including 60 microseconds or more. For example, methods may include irradiating the acousto-optic device with the laser for a duration which ranges from 0.001 microseconds to 100 microseconds, such as from 0.01 microseconds to 75 microseconds, such as from 0.1 microseconds to 50 microseconds, such as from 1 microsecond to 25 microseconds and including from 5 microseconds to 10 microseconds. In embodiments where the acousto-optic device is sequentially irradiated with two or more lasers, the duration the acousto-optic device is irradiated by each laser may be the same or different.

In embodiments, methods include applying radiofrequency drive signals to the acousto-optic device to generate angularly deflected laser beams. Two or more radiofrequency drive signals may be applied to the acousto-optic device to generate an output laser beam with the desired number of angularly deflected laser beams, such as 3 or more radiofrequency drive signals, such as 4 or more radiofrequency drive signals, such as 5 or more radiofrequency drive signals, such as 6 or more radiofrequency drive signals, such as 7 or more radiofrequency drive signals, such as 8 or more radiofrequency drive signals, such as 9 or more radiofrequency drive signals, such as 10 or more radiofrequency drive signals, such as 15 or more radiofrequency drive signals, such as 25 or more radiofrequency drive signals, such as 50 or more radiofrequency drive signals and including 100 or more radiofrequency drive signals.

The angularly deflected laser beams produced by the radiofrequency drive signals each have an intensity based on the amplitude of the applied radiofrequency drive signal. In some embodiments, methods include applying radiofrequency drive signals having amplitudes sufficient to produce angularly deflected laser beams with a desired intensity. In some instances, each applied radiofrequency drive signal independently has an amplitude from about 0.001 V to about 500 V, such as from about 0.005 V to about 400 V, such as from about 0.01 V to about 300 V, such as from about 0.05 V to about 200 V, such as from about 0.1 V to about 100 V, such as from about 0.5 V to about 75 V, such as from about 1 V to 50 V, such as from about 2 V to 40 V, such as from 3 V to about 30 V and including from about 5 V to about 25 V. Each applied radiofrequency drive signal has, in some embodiments, a frequency of from about 0.001 MHz to about 500 MHz, such as from about 0.005 MHz to about 400 MHz, such as from about 0.01 MHz to about 300 MHz, such as from about 0.05 MHz to about 200 MHz, such as from about 0.1 MHz to about 100 MHz, such as from about 0.5 MHz to about 90 MHz, such as from about 1 MHz to about 75 MHz, such as from about 2 MHz to about 70 MHz, such as from about 3 MHz to about 65 MHz, such as from about 4 MHz to about 60 MHz and including from about 5 MHz to about 50 MHz.

In these embodiments, the angularly deflected laser beams in the output laser beam are spatially separated. Depending on the applied radiofrequency drive signals and desired irradiation profile of the output laser beam, the angularly deflected laser beams may be separated by 0.001 μm or more, such as by 0.005 μm or more, such as by 0.01 μm or more, such as by 0.05 μm or more, such as by 0.1 μm or more, such as by 0.5 μm or more, such as by 1 μm or more, such as by 5 μm or more, such as by 10 μm or more, such as by 100 μm or more, such as by 500 μm or more, such as by 1000 μm or more and including by 5000 μm or more. In some embodiments, the angularly deflected laser beams overlap, such as with an adjacent angularly deflected laser beam along a horizontal axis of the output laser beam. The overlap between adjacent angularly deflected laser beams (such as overlap of beam spots) may be an overlap of 0.001 μm or more, such as an overlap of 0.005 μm or more, such as an overlap of 0.01 μm or more, such as an overlap of 0.05 μm or more, such as an overlap of 0.1 μm or more, such as an overlap of 0.5 μm or more, such as an overlap of 1 μm or more, such as an overlap of 5 μm or more, such as an overlap of 10 μm or more and including an overlap of 100 μm or more.

In certain instances, the flow stream is irradiated with a plurality of beams of frequency-shifted light and a cell in the flow stream is imaged by fluorescence imaging using radiofrequency tagged emission (FIRE) to generate a frequency-encoded image, such as those described in Diebold, et al. Nature Photonics Vol. 7(10); 806-810 (2013), as well as described in U.S. Pat. Nos. 9,423,353; 9,784,661; 9,983,132; 10,006,852; 10,078,045; 10,036,699; 10,222,316; 10,288,546; 10,324,019; 10,408,758; 10,451,538; 10,620,111; and U.S. Patent Publication Nos. 2017/0133857; 2017/0328826; 2017/0350803; 2018/0275042; 2019/0376895 and 2019/0376894 the disclosures of which are herein incorporated by reference.

In certain embodiments, light from a plurality of different positions of the flow stream is detected. In embodiments, methods may include detecting light at 10 positions (e.g., segments of a predetermined length) or more across the flow stream, such as 25 positions or more, such as 50 positions or more, such as 75 positions or more, such as 100 positions or more, such as 150 positions or more, such as 200 positions or more, such as 250 positions or more and including 500 positions or more of the flow stream. In some embodiments, light is detected simultaneously from each position across the flow stream. In some embodiments, light from the flow stream is detected with an imaging photodetector, such as where the imaging photodetector detects light simultaneously across the flow stream in a plurality of pixel locations. For example, light from the flow stream may be detected with an imaging photodetector at 10 pixel locations or more across the flow stream, such as 25 pixel locations or more, such as 50 pixel locations or more, such as 75 pixel locations or more, such as 100 pixel locations or more, such as 150 pixel locations or more, such as 200 pixel locations or more, such as 250 pixel locations or more and including 500 pixel locations or more across the horizontal axis of the flow stream. In some instances, each pixel location corresponds to a different position across the horizontal axis of the flow stream.

Photodetectors may be any convenient light detecting protocol, including but not limited to photosensors or photodetectors, such as active-pixel sensors (APSs), avalanche photodiodes (APDs), quadrant photodiodes, image sensors, charge-coupled devices (CCDs), intensified charge-coupled devices (ICCDs), light emitting diodes, photon counters, bolometers, pyroelectric detectors, photoresistors, photovoltaic cells, photodiodes, photomultiplier tubes, phototransistors, quantum dot photoconductors or photodiodes and combinations thereof, among other photodetectors. In certain embodiments, the photodetector is a photomultiplier tube, such as a photomultiplier tube having an active detecting surface area of each region that ranges from 0.01 cm² to 10 cm², such as from 0.05 cm² to 9 cm², such as from, such as from 0.1 cm² to 8 cm², such as from 0.5 cm² to 7 cm² and including from 1 cm² to 5 cm².

Light may be measured by the photodetector at one or more wavelengths, such as at 2 or more wavelengths, such as at 5 or more different wavelengths, such as at 10 or more different wavelengths, such as at 25 or more different wavelengths, such as at 50 or more different wavelengths, such as at 100 or more different wavelengths, such as at 200 or more different wavelengths, such as at 300 or more different wavelengths and including measuring light from particles in the flow stream at 400 or more different wavelengths. Light may be measured continuously or in discrete intervals. In some instances, detectors of interest are configured to take measurements of the light continuously. In other instances, detectors of interest are configured to take measurements in discrete intervals, such as measuring light every 0.001 millisecond, every 0.01 millisecond, every 0.1 millisecond, every 1 millisecond, every 10 milliseconds, every 100 milliseconds and including every 1000 milliseconds, or some other interval. Measurements of the light from across the flow stream may be taken one or more times during each discrete time interval, such as 2 or more times, such as 3 or more times, such as 5 or more times and including 10 or more times. In certain embodiments, the light from the flow stream is measured by the photodetector 2 or more times, with the data in certain instances being averaged.

In practicing the subject methods according to certain embodiments, one or more images of the particle is generated based on the detected light. In some instances, an image of each particle in the sample is generated from data signals from a scattered light detector channel. In certain instances, an image of each particle in the sample is generated from data signals from a forward-scattered light detector channel. In certain instances, an image of each particle in the sample is generated from data signals from a side-scattered light detector channel. In other instances, an image of each particle in the sample is generated from data signals from one or more fluorescence detector channels. In other instances, an image of each particle in the sample is generated from a light loss detector channel. In still other instances, an image of each particle in the sample is generated from a combination of data signals from a light scatter detector channel (e.g., a forward scattered light detector channel or a side-scattered light detector channel) and a fluorescence detector channel. In embodiments, one or more images of each particle may be generated from data signals from each detector channel, such as 2 or more images, such as 3 or more images, such as 4 or more images, such as 5 or more images and including 10 or more images.

In certain embodiments, the images of the particles in the sample are generated from frequency-encoded data (e.g., frequency-encoded fluorescence data). In these embodiments, the frequency-encoded image data is generated by detecting light from a particle in the flow stream that is irradiated with a plurality of frequency shifted beams of light and a local oscillator beam as described in detail above. In one example, a plurality of positions across (a horizontal axis) the particle is irradiated by a laser beam that includes a local oscillator beam and a plurality of radiofrequency-shifted laser beams such that different locations across the particle are irradiated by the local oscillator beam and one of the radiofrequency-shifted beams. In some instances, the local oscillator is a frequency-shifted beam of light from a laser. In this example, each spatial location across the particle in the flow stream is characterized by a different beat frequency which corresponds to the difference between the frequency of the local oscillator beam and the frequency of the radiofrequency-shifted beam at that location. In some embodiments, frequency-encoded image data from the particle includes spatially encoded beat frequencies across a horizontal axis of the particle. In some embodiments, the image of the particle may be generated from the frequency-encoded image data by performing a transform of frequency-encoded data. In one example, the image of the particle is generated by performing a Fourier transform (FT) of the frequency-encoded image data. In another example, the image of the particle is generated by performing a discrete Fourier transform (DFT) of the frequency-encoded image data. In yet another example, the image of the particle is generated by performing a short time Fourier transform (STFT) of the frequency-encoded image data. In still another example, the image of the particle is generated with a digital lock-in amplifier to heterodyne and de-multiplex the frequency-encoded image data.

In embodiments, methods include modulating a visualization parameter of the image of the particle. The term “modulating” is used herein in its conventional sense to refer to a change in a parameter associated with a visual appearance of the particle in the image. As described in greater detail below, modulating the visualization parameter according to some embodiments improves a visual characteristic of the particle in the image. For example, modulating the visual characteristic may include improving resolution of the particle in the image, generating distinct boundaries of the particles in the image, and increasing visualization of sub-cellular components (e.g., intracellular vesicles such as the nucleus of a cell).

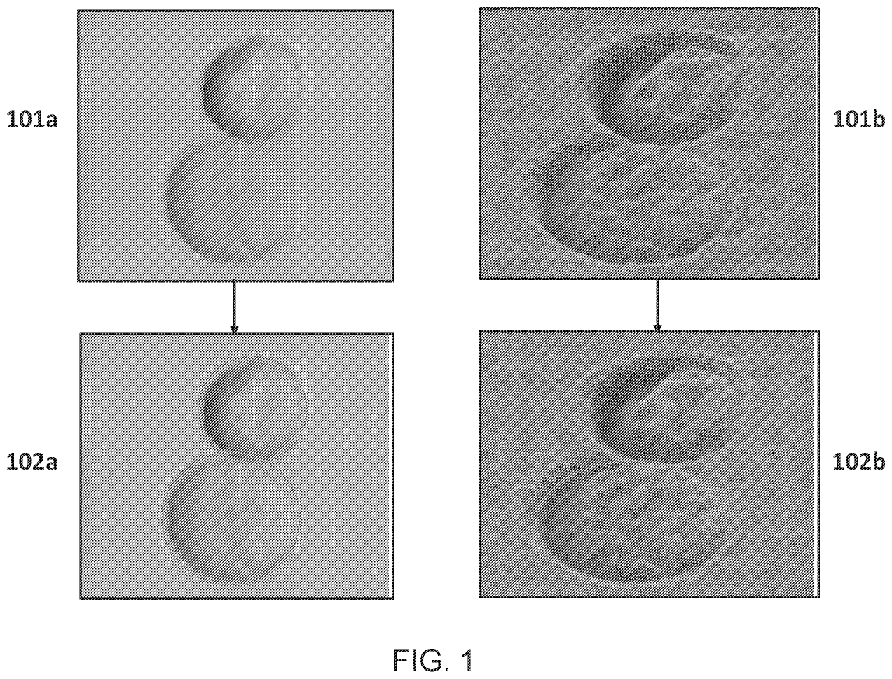

FIG. 1 depicts images of a particle for modulating a visualization parameter according to certain embodiments. Image 101a depicts a two-dimensional image of cells in close proximity when irradiated by the light source in the flow stream. Image 101b depicts a three-dimensional image of the two cells shown in image 101a with increased resolution of the boundaries of the cells. To show that boundaries of the cells, a border is drawn around the cells as shown in images 102a and 102b. The borders drawn around the cells depicts where the signal-to-noise ratio of the data signals (data signals from a scattered light detector channel) used to generate the image exceeds a predetermined visualization threshold and where analysis of the cell images can be used with acceptable noise interference.

In some embodiments, visualization parameters of 2 or more particle images are modulated simultaneously, such as 3 or more, such as 4 or more, such as 5 or more, such as 6 or more, such as 7 or more, such as 8 or more, such as 9 or more, such as 10 or more, such as 25 or more, such as 50 or more, such as 100 or more, such as 250 or more, such as 500 or more and including modulating one or more visualization parameters of 1000 or more particle images simultaneously. In some instances, the particle images are displayed on a graphical user interface and the visualization parameter is modulated in a manner sufficient to change the visual appearance of one or more of the particle images. In certain instances, the graphical user interface displays the particle images in a grid pattern. In other instances, the graphical user interface displays the particle images as a set of tiles. In yet other instances, the graphical interface is an image wall where images of the particles are laid out in a grid pattern and can be organized or moved to different positions on the wall as desired. In certain instances, the particle images displayed on the graphical user interface (e.g., for modulating one or more visualization parameters) are images of particles assigned to a common particle population or parameter cluster. For example, the images displayed together on the graphical user interface (e.g., on an image wall) for modulating a visualization parameter may be images of a population of the same cell type (e.g., T-cells, lymphocytes, etc.).

In some embodiments, the visualization parameter is modulated on the graphical user interface. Any convenient graphical user interface protocol can be used to change the visualization parameter, such as with cursors or with up-and-down arrows. In some instances, the visualization parameter is modulated with a slide bar where movement of the slide bar across a vertical or horizontal axis is sufficient to change the visualization parameter. In other instances, the visualization parameter is modulated by changing a numerical entry on the graphical interface. In some instances, each particle image is individually selected for modulating the visualization parameter with the graphical user interface (e.g., where the slide bar changes the visualization parameter for the selected particle image). In other instances, changes to the visualization parameter using the graphical user interface (e.g., slide bar, up-and-down arrows) is applied to a plurality of different particle images (e.g., particles of a gated population cluster).

In some embodiments, the modulated visualization parameter for a particle image is applied to 2 or more of the generated particle images, such as 3 or more, such as 4 or more, such as 5 or more, such as 6 or more, such as 7 or more, such as 8 or more, such as 9 or more, such as 10 or more, such as 25 or more, such as 50 or more, such as 100 or more, such as 250 or more, such as 500 or more and including where the modulated visualization parameter for a particle image is applied to 1000 or more of the generated particle images. For example, the modulated visualization parameter may be applied to 1% or more of the generated particle images for the particles of the sample, such as 2% or more, such as 3% or more, such as 4% or more, such as 5% or more, such as 10% or more, such as 25% or more, such as 50% or more, such as 75% or more, such as 90% or more, such as 95% or more, such as 99% or more and including where the modulated visualization parameter is applied to all of the generated particle images for the particles of the sample. In certain embodiments, the modulated visualization parameter is applied to the images of particles of a gated particle population or cluster of particles. For example, the modulated visualization parameter may be applied to all images of the particles gated as being a particular cell type (e.g., lymphocytes).

In some embodiments, the visualization parameter is modulated for a region of analysis of the image. In some embodiments, the region of analysis of includes 5% or more of the image (e.g., 5% or more of the pixels of the image), such as 10% or more, such as 15% or more, such as 25% or more, such as 50% or more and including 75% or more of the image. In some instances, the region of analysis includes the pixels of the particle in the image. In certain instances, in the practicing the subject methods the region of analysis is selected such as by highlighting or outlining the region of analysis on one or more of the generated particle images of a graphical user interface. In certain instances, a different region of analysis is selected for each individual particle image. In other instances, a selected region of analysis is applied to 2 or more different particle images, such as 3 or more, such as 4 or more, such as 5 or more, such as 10 or more, such as 25 or more, such as 50 or more, such as 100 or more, such as 250 or more and including where the region of analysis is applied to 500 or more different particle images.

In some embodiments, data signals are generated in each photodetector channel of the light detection system at a plurality of pixel locations of the particle, such as at 10 pixel locations or more of the particle, such as at 25 pixel locations or more, such as at 50 pixel locations or more, such as at 75 pixel locations or more, such as at 100 pixel locations or more, such as at 200 pixel locations or more, such as at 500 pixel locations or more, such as at 10³ pixel locations or more, such as at 10⁴ pixel locations or more, such as at 10⁵ pixel locations or more, such as 10⁶ pixel locations or more, such as at 10⁷ pixel locations or more, such as at 10⁸ pixel locations or more and including at 10⁹ pixel locations or more of the particle. In some instances, the image of the particle is generated based on an intensity of the data signals at all pixel locations that have been assigned to the particle in the image.

In certain embodiments, the region of analysis of the image includes pixel locations of the image which exceed a pixel intensity threshold. In some instances, the region of analysis includes pixel locations where the pixel brightness intensity exceeds the intensity threshold by 0.001% or more, such as by 0.005% or more, such as by 0.01% or more, such as by 0.05% or more, such as by 0.1% or more, such as by 0.5% or more, such as by 1% or more, such as by 2% or more, such as by 3% or more, such as by 4% or more, such as by 5% or more, such as by 10% or more and including where the pixel brightness intensity exceeds the intensity threshold by 15% or more. In some embodiments, the pixel intensity is a signal-to-noise ratio of the data signals from the one or more detector channels used to generate the image of the particle. For example, the pixel intensity may be a signal-to-noise ratio of the data signal from one or more of a forward-scatter photodetector channel, side-scattered photodetector channel, fluorescence photodetector channel and a light loss photodetector channel.

In some embodiments, the visualization parameter is modulated using a color image of the particle. In other embodiments, the visualization parameter is modulated using a black-and-white image of the particle. In yet other embodiments, the visualization parameter is modulated using a greyscale image of the particle. The term “greyscale” is used herein in its conventional sense to refer to an image of the particle that are composed of varying shades of gray that are based on the intensity of light at each pixel. In certain embodiments, methods include generating an image mask of the image. In some instances, a pixel intensity threshold is determined from the greyscale image where the pixel intensity threshold value is used to convert each pixel into a binary value that is used to generate the image mask of the object. In some embodiments, the pixel intensity threshold is determined by minimizing the intra-class variance of the greyscale image and calculating a pixel intensity threshold that is based on the minimized intra-class variance. In some embodiments, the pixel intensity threshold is determined with an algorithm where the detected light data includes two classes of pixels following a bimodal histogram (having foreground pixels and background pixels), calculating an optimum threshold separating the two classes so that their combined intra-class variance is minimal. In other embodiments, methods include calculating an optimum threshold separating the two classes so that their inter-class variance is maximum.

In generating the image mask, each pixel in the greyscale image of the particle is compared against the determined intensity threshold value and converted to a binary pixel value. Each pixel in the greyscale image of the particle may be compared against the determined intensity threshold value in any order as desired. In some embodiments, pixels along each horizontal row in the greyscale image of the particle are compared against the determined intensity threshold value. In some instances, each pixel is compared against the determined intensity threshold value from the left side of the greyscale image of the particle to the right side of the greyscale image of the particle. In other instances, each pixel is compared against the determined intensity threshold value from the right side of the greyscale image of the particle to the left side of the greyscale image of the particle. In other embodiments, pixels along each vertical column in the greyscale image of the particle are compared against the determined intensity threshold value. In some instances, each pixel is compared against the determined intensity threshold value from the top of the greyscale image of the particle to the bottom of the greyscale image of the particle along each vertical column. In other instances, each pixel is compared against the determined intensity threshold value from the bottom of the greyscale image of the particle to the top of the greyscale image of the particle along each vertical column.

In some embodiments, methods include modulating a pixel intensity threshold of one or more of the particle images. In some instances, the pixel intensity threshold is modulated for one or more greyscale images of the particles. In certain instances, the pixel intensity threshold is modulated for the image mask of the particle. In some instances, the pixel intensity threshold is an image mask threshold. In some instances, the pixel intensity threshold is modulated for a scattered light detector channel, such as one or more of a forward scattered light detector channel or a side scattered light detector channel. In other instances, the pixel intensity threshold is modulated for one or more fluorescence detector channels. In yet other instances, the pixel intensity threshold is modulated for a light loss detector channel. In still other instances, the pixel intensity threshold is modulated for a combination of two or more of a scattered light detector channel, a fluorescence detector channel and a light loss detector channel. In some instances, the pixel intensity threshold is modulated for a scattered light detector channel (e.g., side-scatter or forward-scatter) and a fluorescence light detector channel. In certain instances, the pixel intensity threshold is modulated for a forward scattered light detector channel and a fluorescence light detector channel. In certain instances, the pixel intensity threshold is modulated for a side scattered light detector channel and a fluorescence light detector channel.

In certain embodiments, the visualization parameter is modulated when the pixel intensity in two or more detector channels exceeds or does not exceed a predetermined threshold according to a logic selected from:

| | | | |
|---|---|---|---|
| A and B | A or B | A and NOT B | NOT A and B |
| NOT A and NOT | NOT A or B | A or NOT B | A xor B |
| B | | | |
| NOT A or NOT | NOT A xor B | A xor NOT B | NOT A xor NOT |
| B | | | B |

where A and B are independently selected from a forward-scattered light detector channel (FSC); a side-scattered light detector channel (SSC); a fluorescence light detector channel (FL); and a light-loss detector channel (LL).

In some instances, the pixel intensity threshold is the brightness of each pixel in the region of analysis of the image where pixels which exceed the intensity threshold are assigned as being pixels of the particle in the image and pixels which do not exceed the intensity threshold are assigned as not being part of the pixels of the particle in the image. In some instances, the pixel intensity threshold is increased such as by 1% or more, such as by 5% or more, such as by 10% or more, such as by 15% or more, such as by 25% or more, such as by 50% or more, such as by 75% or more, such as by 90% or more, such as by 95% or more, such as by 97% or more and including by increasing the pixel intensity threshold by 99% or more. In other instances, the pixel intensity threshold is decreased such as by 1% or more, such as by 5% or more, such as by 10% or more, such as by 15% or more, such as by 25% or more, such as by 50% or more, such as by 75% or more, such as by 90% or more, such as by 95% or more, such as by 97% or more and including by decreasing the pixel intensity threshold by 99% or more.

In some embodiments, methods include modulating the pixel intensity threshold in a manner sufficient to exceed a threshold visualization of the particle in the region of analysis. In one example, the pixel intensity threshold is modulated until the boundaries of the particle are visualized in the image. In another example, the pixel intensity threshold is modulated in a manner sufficient to improve the resolution of the particle in the region of analysis of the image, such as where the resolution of the particle in the region of analysis of the image is increased by 5% or more, such as by 10% or more, such as by 15% or more, such as by 25% or more, such as by 50% or more, such as by 75% or more, such as by 90% or more, such as by 95% or more, such as by 97% or more and including by increasing the pixel intensity threshold by 99% or more. In another example, the pixel intensity threshold is modulated in a manner sufficient to increase the visualization of subcellular components of cells in the region of analysis of the image, such as where the resolution of subcellular components of cells in the image is increased by 5% or more, such as by 10% or more, such as by 15% or more, such as by 25% or more, such as by 50% or more, such as by 75% or more, such as by 90% or more, such as by 95% or more, such as by 97% or more and including by increasing the pixel intensity threshold by 99% or more. In another example, the pixel intensity threshold is modulated in a manner sufficient to increase the pixel brightness of cellular stain components in the region of analysis of the image, such as where the pixel brightness of cellular stain components in the image is increased by 5% or more, such as by 10% or more, such as by 15% or more, such as by 25% or more, such as by 50% or more, such as by 75% or more, such as by 90% or more, such as by 95% or more, such as by 97% or more and including by increasing the pixel intensity threshold by 99% or more.

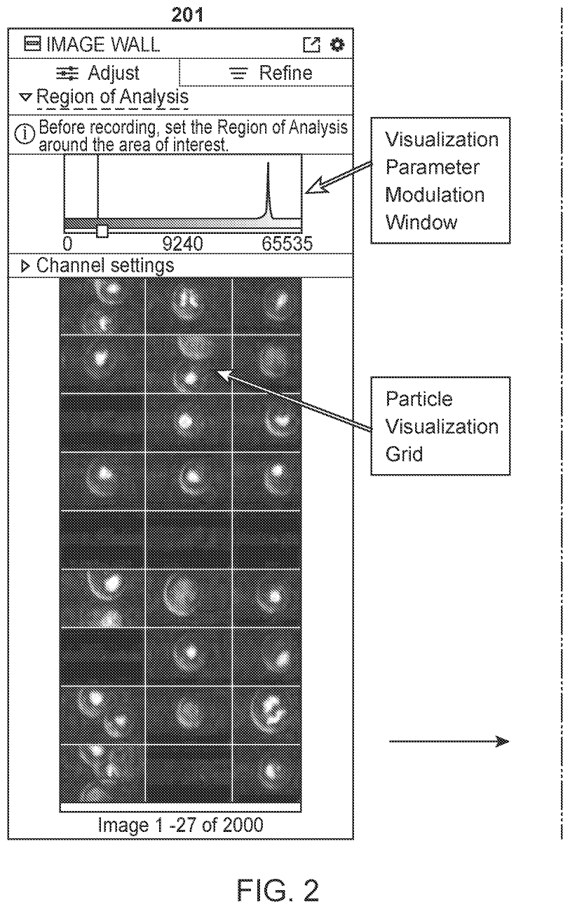

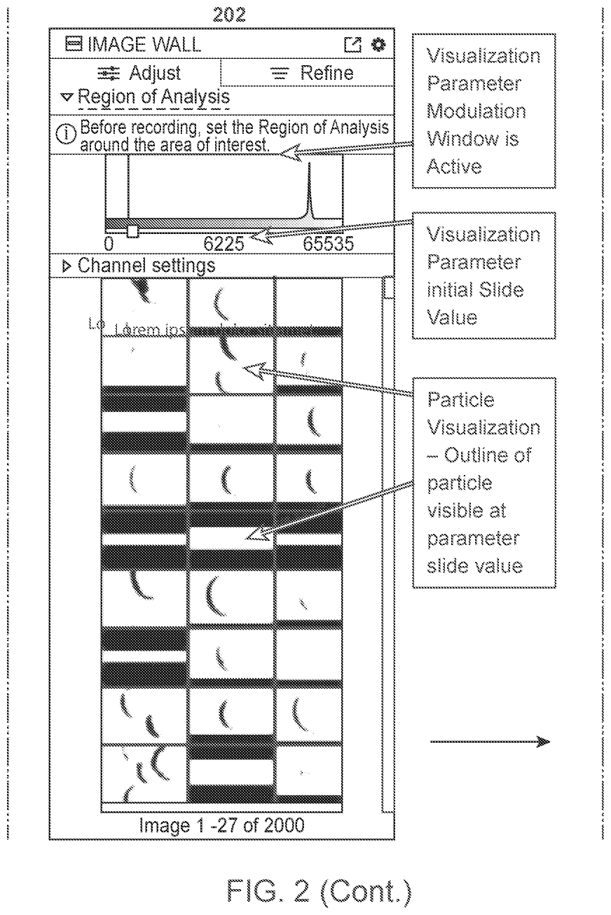

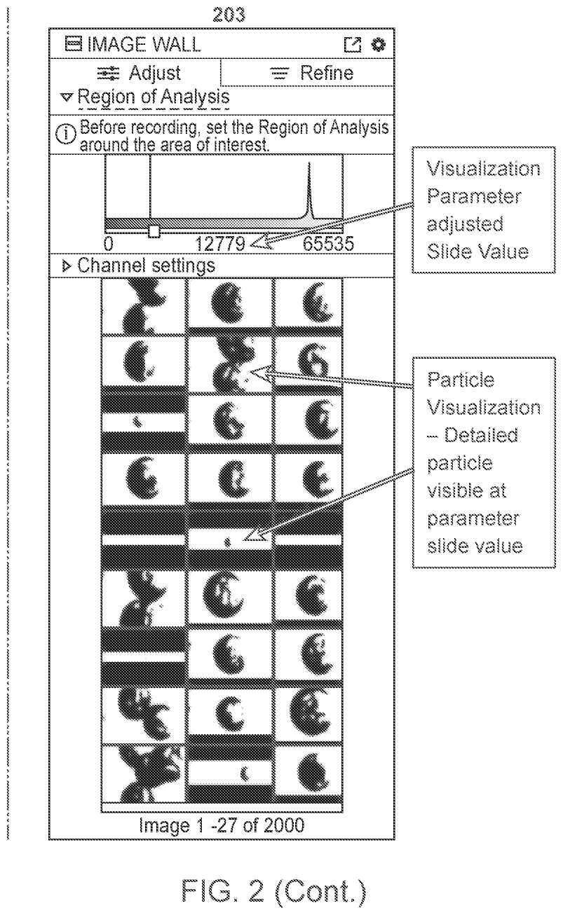

FIG. 2 depicts modulating a visualization parameter of particle images according to certain embodiments. Image 201 depicts an image wall with images of particles of a sample in a grid pattern. The images of the particles are shown based on data signals generated through a fluorescence photodetector channel with user-specified color and intensity. The image wall includes a visualization parameter modulation window where the visual appearance of the particles is adjusted by modulating a selected visualization parameter such as a pixel intensity threshold. Modulation of the visualization parameter is initiated as shown image 202 by activating the visualization parameter modulation window for a region of analysis of the particles in the images. Activating the visualization parameter modulation window in some instances changes the images of the particles to show the particle images generated in a scattered light detector channel. A slide bar on the graphical user interface of the image wall is adjusted to modulate the selected visualization parameter which changes the visual appearance of the particles in the images. This adjustment continues until the visual appearance of the particles is determined to be acceptable as shown in image 203. In some instances, the slide bar is adjusted until the boundaries of the particles in the images are visualized. In other instances, the slide bar is adjusted until the subcellular components of the particles are sufficiently resolved.

In embodiments, methods include automatically adjusting a data acquisition parameter of the particle analyzer in response to a change in the visualization parameter for the particle image. The term “automatically adjusted” is used herein to refer to changing the parameters for acquiring and generating data signals by the particle analyzer hardware (e.g., photodetectors, integrated circuit devices), in certain instances without human intervention or additional command in response to the modulated visualization parameter. In other words, modulation of the visualization parameter for one or more particle images is sufficient to adjust a parameter for one or more of detecting light and generating data signals from the irradiated sample in the flow stream. In some instances, changes to the data acquisition parameters is made in real-time such as where modulation of the visualization parameter dynamically changes the data acquisition parameters. In certain instances, changes to the data acquisition parameters are made immediately in conjunction with modulating the visualization parameter. In other instances, changes to the data acquisition parameters occurs after a predetermined duration after modulation of the visualization parameter. For example, changes to the data acquisition parameters of the particle analyzer may be delayed by 0.00001 seconds or more, such as by 0.00005 seconds or more, such as by 0.0001 seconds or more, such as by 0.0005 seconds or more, such as by 0.001 seconds or more, such as by 0.005 seconds or more, such as by 0.01 seconds or more, such as by 0.05 seconds or more, such as by 0.1 seconds or more, such as by 0.5 seconds or more, such as by 1 second or more, such as by 5 seconds or more, such as by 30 seconds or more, such as by 1 minute or more and including by 5 minutes or more. In some embodiments, the data acquisition parameters of the particle analyzer are automatically adjusted while light from the irradiated sample in the flow stream is being detected. In some instances, modulating the visualization parameter automatically adjusts data acquisition parameters of an integrated circuit device operationally coupled to the particle analyzer. In some embodiments, integrated circuit devices of interest include a field programmable gate array (FPGA). In other embodiments, integrated circuit devices include an application specific integrated circuit (ASIC). In yet other embodiments, integrated circuit devices include a complex programmable logic device (CPLD).

In some instances, a light intensity detection threshold for one or more of the detector channels dynamically adjusted in real time in response to a change in the visualization parameter. For example, modulating a visualization parameter for a particle image in certain instances automatically adjusts a light intensity threshold that is required to generate a data signal from one or more photodetector channels of the particle analyzer. In some instances, an intensity threshold for generating a data signal in a scattered light photodetector channel (e.g., a forward scattered light detector channel or a side scattered light detector channel) is automatically adjusted in response to the modulated visualization parameter. In other instances, an intensity threshold for generating a data signal in a fluorescence photodetector channel is automatically adjusted in response to the modulated visualization parameter. In other instances, an intensity threshold for generating a data signal in a light loss photodetector channel is automatically adjusted in response to the modulated visualization parameter. In some instances, modulating the visualization parameter reduces the threshold intensity of light that generates a data signal from one or more photodetector channel by 0.1% or more, such as by 0.5% or more, such as by 1% or more, such as by 5% or more, such as by 10% or more, such as by 15% or more, such as by 25% or more, such as by 50% or more and including reducing the threshold intensity of light that generates a data signal from one or more photodetector channel by 75% or more. In certain instances, modulating the visualization parameter increases the threshold intensity of light that generates a data signal from one or more photodetector channel by 0.1% or more, such as by 0.5% or more, such as by 1% or more, such as by 5% or more, such as by 10% or more, such as by 15% or more, such as by 25% or more, such as by 50% or more and including increasing the threshold intensity of light that generates a data signal from one or more photodetector channel by 75% or more. In certain embodiments, the data acquisition parameter is a light intensity detection threshold for generating an image. In some instances, an image of the particle is generated when light detected in one or more of the detection channels exceeds the adjusted light intensity detection threshold. In other instances, an image of the particle is not generated when light detected in a light detection channel does not exceed the light intensity threshold.

In some embodiments, an event detection threshold (i.e., determining that a particle is present in the detection region of the flow stream) is automatically adjusted in response to the modulated visualization parameter. In some instances, the event detection threshold is adjusted in a forward scattered light detector channel. In some instances, the event detection threshold is adjusted in a side scattered light detector channel. In certain instances, the event detection threshold is adjusted in a combination of a forward scattered light detector channel and a side scattered light detector channel. In some embodiments, modulating the visualization parameter reduces the threshold for event detection in the photodetector channel by 0.1% or more, such as by 0.5% or more, such as by 1% or more, such as by 5% or more, such as by 10% or more, such as by 15% or more, such as by 25% or more, such as by 50% or more and including reducing the event detection threshold by 75% or more. In certain instances, modulating the visualization parameter increases the threshold for event detection in the photodetector channel by 0.1% or more, such as by 0.5% or more, such as by 1% or more, such as by 5% or more, such as by 10% or more, such as by 15% or more, such as by 25% or more, such as by 50% or more and including increasing the threshold for event detection in the photodetector channel by 75% or more.

In certain embodiments, the particle analyzer is configured to sort particles of the sample. The term “sorting” is used herein in its conventional sense to refer to separating components (e.g., droplets containing cells, droplets containing non-cellular particles such as biological macromolecules) of a sample and in some instances, delivering the separated components to one or more sample collection containers. For example, methods may include sorting 2 or more components of the sample, such as 3 or more components, such as 4 or more components, such as 5 or more components, such as 10 or more components, such as 15 or more components and including sorting 25 or more components of the sample. In some embodiments, the object is identified as being a single cell and is sorted to a first sample component collection location. In other embodiments, the object is identified as being a cell aggregate and is sorted to a second sample component collection location. In some instances, the first sample component collection location includes a sample collection container and the second sample component collection location includes a waste collection container. In sorting the object from the sample in the flow stream, a particular subpopulation of interest (e.g., single cells) may then further analyzed by “gating” based on the data collected for the entire population. In some embodiments, a sorting parameter for the particle analyzer is automatically adjusted in response to a change in the visualization parameter. In some instances, a sorting gate is automatically adjusted in response to the modulated visualization parameter. For example, a sorting gate for one or more particle populations in the sample may be dynamically adjusted in real time in response to a change in a visualization parameter for a particle image.

In some embodiments, modulating the visualization parameter automatically expands a sorting gate to increase the number of particles that are sorted in the sample, such as where the population of particles gated for sorting is increased by 5% or more, such as by 10% or more, such as by 25% or more, such as by 50% or more and including where the population of particles gated for sorting is increased by 75% or more. In some instances, modulating the visualization parameter reduces the size of the sorting gate such that the population of particles gated for sorting is decreased by 5% or more, such as by 10% or more, such as by 25% or more, such as by 50% or more and including where the population of particles gated for sorting is decreased by 75% or more. In certain embodiments, modulating the visualization parameter provides for changing a sorting gate to be specific to a target population of particles in the sample, such as where particles of a sample that are gated to be sorted are of the same cell type (e.g., lymphocytes). In other embodiments, modulating the visualization parameter provides for changing a sorting gate to be specific for particles having the same size. In yet other embodiments, modulating the visualization parameter provides for changing a sorting gate to be specific for particles which exhibit the same fluorescence markers.

In some embodiments, methods include assessing particle images after the adjustments to the data acquisition parameters have been made to the particle analyzer (e.g., to the firmware of the particle analyzer). In some instances, assessing the particle images includes determining whether further visualization modulation is required based on acquired particle images after the data acquisition parameter have been adjusted. Where further optimization is needed or desired, methods may include modulating the same or a different visualization parameter in response to the newly acquired particle images. Modulating the visualization parameters of the particle images may be repeated 1 or more times, such as 2 or more times, such as 3 or more times, such as 4 or more times, such as 5 or more times and including 10 or more times.

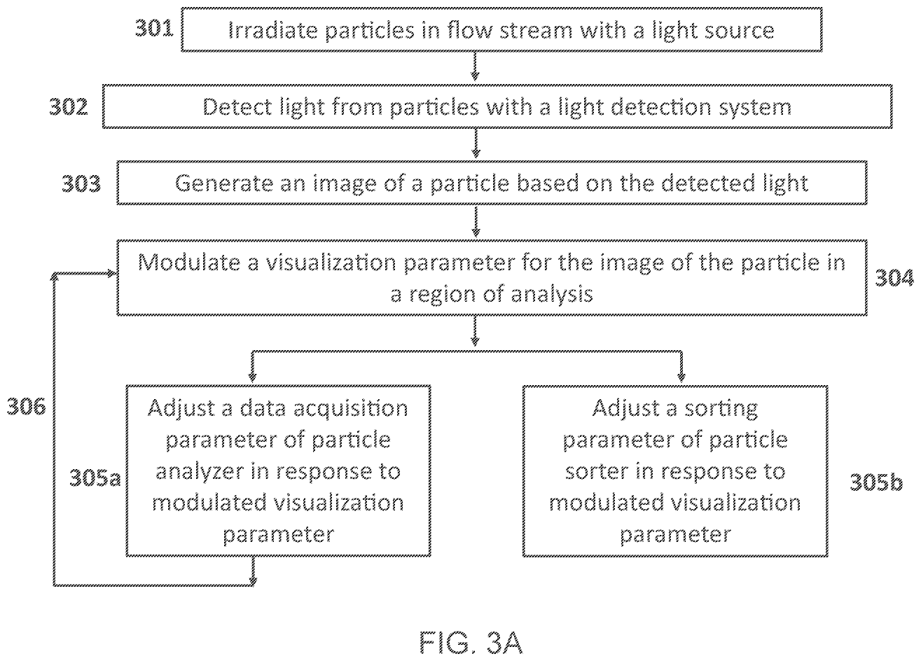

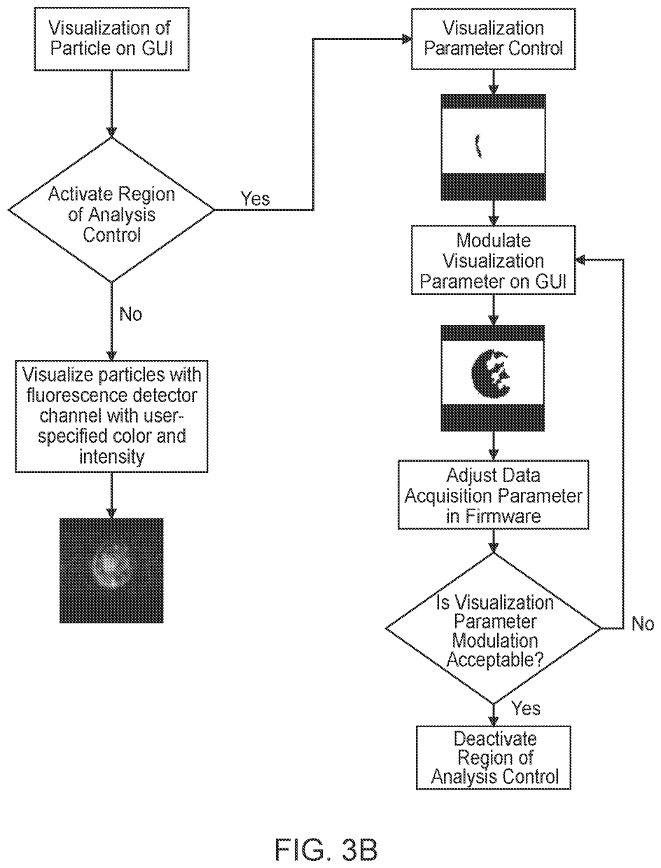

FIG. 3A depicts a flow chart for dynamic real-time adjustment of a data acquisition parameter of a particle analyzer according to certain embodiments. As shown in 301, particles in a sample are irradiated in a flow stream with a light source and light is detected from the particles with a light detection system at 302. An image of the particles are generated at 303 based on data signals from one or more photodetector channels such as data signals from a scattered light detector channel (e.g., forward scatter image data, side scatter image data), one or more fluorescence detector channels (e.g., fluorescent marker image data) and a light loss detector channel. A visualization parameter such as a pixel intensity threshold is modulated in a region of analysis for images of one or more particles at 304. In some instances, a data acquisition parameter such as a light detection threshold (e.g., a trigger threshold) of the particle analyzer is automatically adjusted at 305a in response to a change in the visualization threshold. In certain instances, a sorting parameter (e.g., a sorting gate) is automatically adjusted at 305b in response to the change in the visualization threshold. In some embodiments, where further adjustment to the data acquisition parameter or visualization parameter is determined to be necessary, methods may include further modulation at 306 of the same or a different visualization parameter for the particle image (or a different particle image, such as a particle image generated after adjustment of the data acquisition parameter).

FIG. 3B depicts a flow chart for dynamically adjusting a firmware parameter during data acquisition for a particle analyzer according to certain embodiments. During data acquisition (i.e., while particles of a sample are propagated through and irradiated in the flow stream of the particle analyzer), a particle is visualized on a graphical user interface (GUI) such as an image wall as depicted in FIG. 2. To modulate a visualization parameter of the particle image, a region of analysis control is activated on the graphical user interface. In certain instances, before the region of analysis control is activated, particles on the image wall are visualized through one or more of the detector channels, such as with the fluorescence detector channel that shows user-specified color and intensity values for each particle image. After activating the region of analysis control, the particle image may be displayed on the graphical user interface based on data signals from one or more photodetector channels. In some instances, activating the region of analysis control provides for visualizing the particle image based on data signals from a side scattered light or forward scattered light detector channel. A visualization parameter (e.g., a pixel intensity threshold, a mask threshold or a signal-to-noise threshold) is modulated using the graphical interface for the selected particle image. For example, the visualization parameter may be modulated by moving a slide bar such as with the graphical user interfaces shown in FIG. 2. In some instances, the visualization parameter is modulated until the image of the particle exhibits a desired characteristic such as improved resolution of sub-cellular components or delineated boundaries for each particle in the images. Modulation of the visualization parameter on the graphical user interface automatically adjusts a data acquisition parameter in the firmware of the particle analyzer such that data associated with particles irradiated after the visualization parameter is modulated is acquired with the updated or adjusted parameters implemented in the firmware of the particle analyzer. Particle images are reassessed to determine whether the visualization parameter is acceptable as desired. Where the particle images require further optimization, the same or different visualization parameter may be modulated further using the region of analysis control of the graphical user interface. In some instances, the images of the particles may be “locked in” by deactivating the region of analysis control. Images that are “locked in” may be stored as collected image data for later analysis.

Systems with Dynamic Real-Time Adjustment of Data Acquisition Parameters

Aspects of the present disclosure also include systems (e.g., particle analyzer) having a light detection system that includes an imaging photodetector. In embodiments, the light detection system is configured to detect light from particles of a sample in a flow stream irradiated with a light source (e.g., a laser) and a processor having memory operably coupled to the processor where the memory includes instructions stored thereon, which when executed by the processor, cause the processor to generate an image of each particle based on the detected light, modulate a visualization parameter for the image of a particle in the flow stream and automatically adjust a data acquisition parameter of the system in response to the modulated visualization parameter. As discussed above, dynamic adjustments to data acquisition parameters of the subject systems provide improved accuracy in measuring cell-image characteristics. In certain instances, adjustments to the data acquisition parameters of the particle analyzer minimizes or altogether eliminates photodetector signal noise, such as where photodetector signal noise is reduced by 5% or more, such as by 10% or more, such as by 25% or more, such as by 50% or more, such as by 75% or more, such as by 90% or more and including by 99% or more. In certain embodiments, adjustments to the data acquisition parameters of the particle analyzer broaden the range of intensity detection and quantitation by 2-fold or greater, such as by 3-fold or greater, such as by 5-fold or greater, such as by 10-fold or greater, such as by 25-fold or greater, such as by 50-fold or greater and including by 100-fold or greater. In other instances, the dynamic adjustments to the data acquisition parameters of the particle analyzer are sufficient to reduce or eliminate photodetector signal intensity variation, such as where photodetector signal intensity varies by 5% or less, such as by 4% or less, such as by 3% or less, such as by 2% or less, such as by 1% or less, such as by 0.5% or less, such as by 0.1% or less, such as by 0.05% or less, such as by 0.01% or less, such as by 0.005% or less.

In some embodiments, systems include a light source for irradiating a sample having particles in a flow stream. Systems of interest include a light source configured to irradiate a sample in a flow stream. In embodiments, the light source may be any suitable broadband or narrow band source of light. Depending on the components in the sample (e.g., cells, beads, non-cellular particles, etc.), the light source may be configured to emit wavelengths of light that vary, ranging from 200 nm to 1500 nm, such as from 250 nm to 1250 nm, such as from 300 nm to 1000 nm, such as from 350 nm to 900 nm and including from 400 nm to 800 nm. For example, the light source may include a broadband light source emitting light having wavelengths from 200 nm to 900 nm. In other instances, the light source includes a narrow band light source emitting a wavelength ranging from 200 nm to 900 nm. For example, the light source may be a narrow band LED (1 nm-25 nm) emitting light having a wavelength ranging between 200 nm to 900 nm.

In some embodiments, the light source is a laser. Lasers of interest may include pulsed lasers or continuous wave lasers. For example, the laser may be a gas laser, such as a helium-neon laser, argon laser, krypton laser, xenon laser, nitrogen laser, CO₂ laser, CO laser, argon-fluorine (ArF) excimer laser, krypton-fluorine (KrF) excimer laser, xenon chlorine (XeCl) excimer laser or xenon-fluorine (XeF) excimer laser or a combination thereof; a dye laser, such as a stilbene, coumarin or rhodamine laser; a metal-vapor laser, such as a helium-cadmium (HeCd) laser, helium-mercury (HeHg) laser, helium-selenium (HeSe) laser, helium-silver (HeAg) laser, strontium laser, neon-copper (NeCu) laser, copper laser or gold laser and combinations thereof; a solid-state laser, such as a ruby laser, an Nd:YAG laser, NdCrYAG laser, Er:YAG laser, Nd:YLF laser, Nd:YVO₄ laser, Nd:YCa₄O(BO₃)₃ laser, Nd:YCOB laser, titanium sapphire laser, thulim YAG laser, ytterbium YAG laser, ytterbium₂O₃ laser or cerium doped lasers and combinations thereof; a semiconductor diode laser, optically pumped semiconductor laser (OPSL), or a frequency doubled- or frequency tripled implementation of any of the above mentioned lasers.

In other embodiments, the light source is a non-laser light source, such as a lamp, including but not limited to a halogen lamp, deuterium arc lamp, xenon arc lamp, a light-emitting diode, such as a broadband LED with continuous spectrum, superluminescent emitting diode, semiconductor light emitting diode, wide spectrum LED white light source, an multi-LED integrated. In some instances the non-laser light source is a stabilized fiber-coupled broadband light source, white light source, among other light sources or any combination thereof.

In certain embodiments, the light source is a light beam generator that is configured to generate two or more beams of frequency shifted light. In some instances, the light beam generator includes a laser, a radiofrequency generator configured to apply radiofrequency drive signals to an acousto-optic device to generate two or more angularly deflected laser beams. In these embodiments, the laser may be a pulsed lasers or continuous wave laser. The acousto-optic device may be any convenient acousto-optic protocol configured to frequency shift laser light using applied acoustic waves. In certain embodiments, the acousto-optic device is an acousto-optic deflector. The acousto-optic device in the subject system is configured to generate angularly deflected laser beams from the light from the laser and the applied radiofrequency drive signals. The radiofrequency drive signals may be applied to the acousto-optic device with any suitable radiofrequency drive signal source, such as a direct digital synthesizer (DDS), arbitrary waveform generator (AWG), or electrical pulse generator.

In embodiments, a controller is configured to apply radiofrequency drive signals to the acousto-optic device to produce the desired number of angularly deflected laser beams in the output laser beam, such as being configured to apply 3 or more radiofrequency drive signals, such as 4 or more radiofrequency drive signals, such as 5 or more radiofrequency drive signals, such as 6 or more radiofrequency drive signals, such as 7 or more radiofrequency drive signals, such as 8 or more radiofrequency drive signals, such as 9 or more radiofrequency drive signals, such as 10 or more radiofrequency drive signals, such as 15 or more radiofrequency drive signals, such as 25 or more radiofrequency drive signals, such as 50 or more radiofrequency drive signals and including being configured to apply 100 or more radiofrequency drive signals.

In some instances, to produce an intensity profile of the angularly deflected laser beams in the output laser beam, the controller is configured to apply radiofrequency drive signals having an amplitude that varies such as from about 0.001 V to about 500 V, such as from about 0.005 V to about 400 V, such as from about 0.01 V to about 300 V, such as from about 0.05 V to about 200 V, such as from about 0.1 V to about 100 V, such as from about 0.5 V to about 75 V, such as from about 1 V to 50 V, such as from about 2 V to 40 V, such as from 3 V to about 30 V and including from about 5 V to about 25 V. Each applied radiofrequency drive signal has, in some embodiments, a frequency of from about 0.001 MHz to about 500 MHz, such as from about 0.005 MHz to about 400 MHz, such as from about 0.01 MHz to about 300 MHz, such as from about 0.05 MHz to about 200 MHz, such as from about 0.1 MHz to about 100 MHz, such as from about 0.5 MHz to about 90 MHz, such as from about 1 MHz to about 75 MHz, such as from about 2 MHz to about 70 MHz, such as from about 3 MHz to about 65 MHz, such as from about 4 MHz to about 60 MHz and including from about 5 MHz to about 50 MHz.

In certain embodiments, the controller has a processor having memory operably coupled to the processor such that the memory includes instructions stored thereon, which when executed by the processor, cause the processor to produce an output laser beam with angularly deflected laser beams having a desired intensity profile. For example, the memory may include instructions to produce two or more angularly deflected laser beams with the same intensities, such as 3 or more, such as 4 or more, such as 5 or more, such as 10 or more, such as 25 or more, such as 50 or more and including memory may include instructions to produce 100 or more angularly deflected laser beams with the same intensities. In other embodiments, the may include instructions to produce two or more angularly deflected laser beams with different intensities, such as 3 or more, such as 4 or more, such as 5 or more, such as 10 or more, such as 25 or more, such as 50 or more and including memory may include instructions to produce 100 or more angularly deflected laser beams with different intensities.

In certain instances, light beam generators configured to generate two or more beams of frequency shifted light include laser excitation modules as described in U.S. Pat. Nos. 9,423,353; 9,784,661 and 10,006,852 and U.S. Patent Publication Nos. 2017/0133857 and 2017/0350803, the disclosures of which are herein incorporated by reference.

In embodiments, systems include a light detection system having one or more photodetectors for detecting and measuring light from the sample. Photodetectors of interest may be configured to measure light absorption (e.g., for brightfield light data), light scatter (e.g., forward or side scatter light data), light emission (e.g., fluorescence light data) from the sample or a combination thereof. Photodetectors of interest may include, but are not limited to optical sensors, such as active-pixel sensors (APSs), avalanche photodiodes (APDs), image sensors, charge-coupled devices (CCDs), intensified charge-coupled devices (ICCDs), light emitting diodes, photon counters, bolometers, pyroelectric detectors, photoresistors, photovoltaic cells, photodiodes, photomultiplier tubes, phototransistors, quantum dot photoconductors or photodiodes and combinations thereof, among other photodetectors. In certain embodiments, light from a sample is measured with a charge-coupled device (CCD), semiconductor charge-coupled devices (CCD), active pixel sensors (APS), complementary metal-oxide semiconductor (CMOS) image sensors or N-type metal-oxide semiconductor (NMOS) image sensors.

In some embodiments, light detection systems of interest include a plurality of photodetectors. In some instances, the light detection system includes a plurality of solid-state detectors such as photodiodes. In certain instances, the light detection system includes a photodetector array, such as an array of photodiodes. In these embodiments, the photodetector array may include 4 or more photodetectors, such as 10 or more photodetectors, such as 25 or more photodetectors, such as 50 or more photodetectors, such as 100 or more photodetectors, such as 250 or more photodetectors, such as 500 or more photodetectors, such as 750 or more photodetectors and including 1000 or more photodetectors. For example, the detector may be a photodiode array having 4 or more photodiodes, such as 10 or more photodiodes, such as 25 or more photodiodes, such as 50 or more photodiodes, such as 100 or more photodiodes, such as 250 or more photodiodes, such as 500 or more photodiodes, such as 750 or more photodiodes and including 1000 or more photodiodes.

The photodetectors may be arranged in any geometric configuration as desired, where arrangements of interest include, but are not limited to a square configuration, rectangular configuration, trapezoidal configuration, triangular configuration, hexagonal configuration, heptagonal configuration, octagonal configuration, nonagonal configuration, decagonal configuration, dodecagonal configuration, circular configuration, oval configuration as well as irregular patterned configurations. The photodetectors in the photodetector array may be oriented with respect to the other (as referenced in an X-Z plane) at an angle ranging from 10° to 180°, such as from 15° to 170°, such as from 20° to 160°, such as from 25° to 150°, such as from 30° to 120° and including from 45° to 90°. The photodetector array may be any suitable shape and may be a rectilinear shape, e.g., squares, rectangles, trapezoids, triangles, hexagons, etc., curvilinear shapes, e.g., circles, ovals, as well as irregular shapes, e.g., a parabolic bottom portion coupled to a planar top portion. In certain embodiments, the photodetector array has a rectangular-shaped active surface.

Each photodetector (e.g., photodiode) in the array may have an active surface with a width that ranges from 5 μm to 250 μm, such as from 10 μm to 225 μm, such as from 15 μm to 200 μm, such as from 20 μm to 175 μm, such as from 25 μm to 150 μm, such as from 30 μm to 125 μm and including from 50 μm to 100 μm and a length that ranges from 5 μm to 250 μm, such as from 10 μm to 225 μm, such as from 15 μm to 200 μm, such as from 20 μm to 175 μm, such as from 25 μm to 150 μm, such as from 30 μm to 125 μm and including from 50 μm to 100 μm, where the surface area of each photodetector (e.g., photodiode) in the array ranges from 25 to μm² to 10000 μm², such as from 50 to μm² to 9000 μm², such as from 75 to μm² to 8000 μm², such as from 100 to μm² to 7000 μm², such as from 150 to μm² to 6000 μm² and including from 200 to μm² to 5000 μm².

The size of the photodetector array may vary depending on the amount and intensity of the light, the number of photodetectors and the desired sensitivity and may have a length that ranges from 0.01 mm to 100 mm, such as from 0.05 mm to 90 mm, such as from 0.1 mm to 80 mm, such as from 0.5 mm to 70 mm, such as from 1 mm to 60 mm, such as from 2 mm to 50 mm, such as from 3 mm to 40 mm, such as from 4 mm to 30 mm and including from 5 mm to 25 mm. The width of the photodetector array may also vary, ranging from 0.01 mm to 100 mm, such as from 0.05 mm to 90 mm, such as from 0.1 mm to 80 mm, such as from 0.5 mm to 70 mm, such as from 1 mm to 60 mm, such as from 2 mm to 50 mm, such as from 3 mm to 40 mm, such as from 4 mm to 30 mm and including from 5 mm to 25 mm. As such, the active surface of the photodetector array may range from 0.1 mm² to 10000 mm², such as from 0.5 mm² to 5000 mm², such as from 1 mm² to 1000 mm², such as from 5 mm² to 500 mm², and including from 10 mm² to 100 mm².

Photodetectors of interest are configured to measure collected light at one or more wavelengths, such as at 2 or more wavelengths, such as at 5 or more different wavelengths, such as at 10 or more different wavelengths, such as at 25 or more different wavelengths, such as at 50 or more different wavelengths, such as at 100 or more different wavelengths, such as at 200 or more different wavelengths, such as at 300 or more different wavelengths and including measuring light emitted by a sample in the flow stream at 400 or more different wavelengths.

In some embodiments, photodetectors are configured to measure collected light over a range of wavelengths (e.g., 200 nm-1000 nm). In certain embodiments, photodetectors of interest are configured to collect spectra of light over a range of wavelengths. For example, systems may include one or more detectors configured to collect spectra of light over one or more of the wavelength ranges of 200 nm-1000 nm. In yet other embodiments, detectors of interest are configured to measure light from the sample in the flow stream at one or more specific wavelengths. For example, systems may include one or more detectors configured to measure light at one or more of 450 nm, 518 nm, 519 nm, 561 nm, 578 nm, 605 nm, 607 nm, 625 nm, 650 nm, 660 nm, 667 nm, 670 nm, 668 nm, 695 nm, 710 nm, 723 nm, 780 nm, 785 nm, 647 nm, 617 nm and any combinations thereof.

The light detection system is configured to measure light continuously or in discrete intervals. In some instances, photodetectors of interest are configured to take measurements of the collected light continuously. In other instances, the light detection system is configured to take measurements in discrete intervals, such as measuring light every 0.001 millisecond, every 0.01 millisecond, every 0.1 millisecond, every 1 millisecond, every 10 milliseconds, every 100 milliseconds and including every 1000 milliseconds, or some other interval.

In some embodiments, the light detection system is configured to detect light from a plurality of different positions of the flow stream. In some embodiments, the light detection system is configured to detect light from flow stream at 10 positions (e.g., segments of a predetermined length) or more, such as 25 positions or more, such as 50 positions or more, such as 75 positions or more, such as 100 positions or more, such as 150 positions or more, such as 200 positions or more, such as 250 positions or more and including 500 positions or more of the flow stream. In some embodiments, the light detection system is configured to detect light simultaneously from each position of the flow stream. In some embodiments, the light detection system includes an imaging photodetector which detects light simultaneously across the flow stream in a plurality of pixel locations. For example, the imaging photodetector may be configured to detect light from the flow stream at 10 pixel locations or more across the flow stream, such as 25 pixel locations or more, such as 50 pixel locations or more, such as 75 pixel locations or more, such as 100 pixel locations or more, such as 150 pixel locations or more, such as 200 pixel locations or more, such as 250 pixel locations or more and including 500 pixel locations or more across the horizontal axis of the flow stream. In some instances, each pixel location corresponds to a different position of the flow stream.

In embodiments, systems include a processor having memory operably coupled to the processor where the memory includes instructions stored thereon, which when executed by the processor, cause the processor to generate an image of each particle based on the detected light. In some instances, the system is configured to generate an image of each particle in the sample from data signals from a scattered light detector channel. In certain instances, the system is configured to generate an image of each particle in the sample from data signals from a forward-scattered light detector channel. In certain instances, the system is configured to generate an image of each particle in the sample from data signals from a side-scattered light detector channel. In other instances, the system is configured to generate an image of each particle in the sample from data signals from one or more fluorescence detector channels. In other instances, the system is configured to generate an image of each particle in the sample from a light loss detector channel. In still other instances, the system is configured to generate an image of each particle in the sample from a combination of data signals from a light scatter detector channel (e.g., a forward scattered light detector channel or a side-scattered light detector channel) and a fluorescence detector channel. In embodiments, the system may be configured to generate one or more images of each particle from data signals from each detector channel, such as 2 or more images, such as 3 or more images, such as 4 or more images, such as 5 or more images and including 10 or more images. In some embodiments, systems include a computer having a computer readable storage medium with a computer program stored thereon, where the computer program when loaded on the computer includes instructions for generating a images of the particles of the sample from frequency-encoded data (e.g., frequency-encoded fluorescence data). In some embodiments, systems are configured to generate the frequency-encoded image data by detecting light from a particle in the flow stream that is irradiated with a plurality of frequency shifted beams of light and a local oscillator beam as described in detail above.

In embodiments, systems include a processor having memory operably coupled to the processor where the memory includes instructions stored thereon, which when executed by the processor, cause the processor to modulate a visualization parameter of an image of a particle. As described above, modulating the visualization parameter according to some embodiments improves a visual characteristic of the particle in the image. For example, modulating the visual characteristic may include improving resolution of the particle in the image, generating distinct boundaries of the particles in the image, and increasing visualization of sub-cellular components. In some instances, the memory includes instructions for modulating the visualization parameters of 2 or more particle images simultaneously, such as 3 or more, such as 4 or more, such as 5 or more, such as 6 or more, such as 7 or more, such as 8 or more, such as 9 or more, such as 10 or more, such as 25 or more, such as 50 or more, such as 100 or more, such as 250 or more, such as 500 or more and including 1000 or more particle images simultaneously.

In some instances, systems include a display with a graphical user interface where the particle images are displayed and the visualization parameter is modulated (e.g., by a user) in a manner sufficient to change the visual appearance of one or more of the particle images. In certain instances, the graphical user interface displays the particle images in a grid pattern. In other instances, the graphical user interface displays the particle images as a set of tiles. In yet other instances, the graphical interface is an image wall where images of the particles are laid out in a grid pattern and can be organized or moved to different positions on the wall as desired. In certain instances, the particle images displayed on the graphical user interface (e.g., for modulating one or more visualization parameters) are images of particles assigned to a common particle population or parameter cluster. For example, the images displayed together on the graphical user interface (e.g., on an image wall) for modulating a visualization parameter may be images of a population of the same cell type (e.g., T-cells, lymphocytes, etc.). In some instances, the graphical user interface includes a slide bar for modulating the visualization parameter where movement of the slide bar across a vertical or horizontal axis is sufficient to change the visualization parameter. In other instances, the graphical user interface includes numerical entry box where the visualization parameter is modulated by changing a numerical entry. In some instances, each particle image is individually selected for modulating the visualization parameter with the graphical user interface (e.g., where the slide bar changes the visualization parameter for the selected particle image). In other instances, changes to the visualization parameter using the graphical user interface (e.g., slide bar, up-and-down arrows) is applied to a plurality of different particle images (e.g., particles of a gated population cluster).

In some embodiments, the memory includes instructions for applying the modulated visualization parameter for a particle image to 2 or more of the generated particle images, such as 3 or more, such as 4 or more, such as 5 or more, such as 6 or more, such as 7 or more, such as 8 or more, such as 9 or more, such as 10 or more, such as 25 or more, such as 50 or more, such as 100 or more, such as 250 or more, such as 500 or more and applying the modulated visualization parameter to 1000 or more of the generated particle images. For example, the modulated visualization parameter may be applied to 1% or more of the generated particle images for the particles of the sample, such as 2% or more, such as 3% or more, such as 4% or more, such as 5% or more, such as 10% or more, such as 25% or more, such as 50% or more, such as 75% or more, such as 90% or more, such as 95% or more, such as 99% or more and including where the modulated visualization parameter is applied to all of the generated particle images for the particles of the sample. In certain embodiments, the memory includes instructions for applying the modulated visualization parameter to the images of particles of a gated particle population or cluster of particles. For example, the modulated visualization parameter may be applied to all images of the particles gated as being a particular cell type (e.g., lymphocytes).

In some embodiments, the memory includes instructions for modulating a visualization parameter for a region of analysis of the particle image. In some embodiments, the region of analysis of includes 5% or more of the image (e.g., 5% or more of the pixels of the image), such as 10% or more, such as 15% or more, such as 25% or more, such as 50% or more and including 75% or more of the image. In certain instances, the memory includes instructions for using a different region of analysis for each individual particle image. In other instances, the memory includes instructions for applying a selected region of analysis to 2 or more different particle images, such as 3 or more, such as 4 or more, such as 5 or more, such as 10 or more, such as 25 or more, such as 50 or more, such as 100 or more, such as 250 or more and including where the region of analysis is applied to 500 or more different particle images. In certain embodiments, the region of analysis of the image includes pixel locations of the image which exceed a pixel intensity threshold. In some instances, the region of analysis includes pixel locations where the pixel brightness intensity exceeds the intensity threshold by 0.001% or more, such as by 0.005% or more, such as by 0.01% or more, such as by 0.05% or more, such as by 0.1% or more, such as by 0.5% or more, such as by 1% or more, such as by 2% or more, such as by 3% or more, such as by 4% or more, such as by 5% or more, such as by 10% or more and including where the pixel brightness intensity exceeds the intensity threshold by 15% or more. In some embodiments, the pixel intensity is a signal-to-noise ratio of the data signals from the one or more detector channels used to generate the image of the particle. For example, the pixel intensity may be a signal-to-noise ratio of the data signal from one or more of a forward-scatter photodetector channel, side-scattered photodetector channel, fluorescence photodetector channel and a light loss photodetector channel.

In certain embodiments, systems include a processor having memory operably coupled to the processor where the memory includes instructions stored thereon, which when executed by the processor, cause the processor to modulate a pixel intensity threshold of one or more of the particle images. In some instances, the memory includes instructions for modulating a pixel intensity threshold for one or more greyscale images of the particles. In certain instances, the memory includes instructions for modulating the pixel intensity threshold for an image mask of the particle. In some instances, the pixel intensity threshold is an image mask threshold. In some instances, the memory includes instructions for modulating the pixel intensity threshold for a scattered light detector channel, such as one or more of a forward scattered light detector channel or a side scattered light detector channel. In other instances, the memory includes instructions for modulating the pixel intensity threshold for one or more fluorescence detector channels. In yet other instances, the memory includes instructions for modulating the pixel intensity threshold for a light loss detector channel. In still other instances, the memory includes instructions for modulating the pixel intensity threshold for a combination of two or more of a scattered light detector channel, a fluorescence detector channel and a light loss detector channel. In some instances, the memory includes instructions for modulating the pixel intensity threshold for a scattered light detector channel (e.g., side-scatter or forward-scatter) and a fluorescence light detector channel. In certain instances, the memory includes instructions for modulating a pixel intensity threshold for a forward scattered light detector channel and a fluorescence light detector channel. In certain instances, the memory includes instructions for modulating a pixel intensity threshold for a side scattered light detector channel and a fluorescence light detector channel.

In certain embodiments, the memory includes instructions for modulating a visualization parameter when the pixel intensity in two or more detector channels exceeds or does not exceed a predetermined threshold according to a logic selected from:

| | | | |
|---|---|---|---|
| A and B | A or B | A and NOT B | NOT A and B |
| NOT A and NOT | NOT A or B | A or NOT B | A xor B |
| B | | | |
| NOT A or NOT | NOT A xor B | A xor NOT B | NOT A xor NOT |
| B | | | B |

where A and B are independently selected from a forward-scattered light detector channel (FSC); a side-scattered light detector channel (SSC); a fluorescence light detector channel (FL); and a light-loss detector channel (LL).

In some embodiments, the memory includes instructions for modulating the pixel intensity threshold in a manner sufficient to exceed a threshold visualization of the particle in the region of analysis. In one example, the pixel intensity threshold is modulated until the boundaries of the particle are visualized in the image. In another example, the pixel intensity threshold is modulated in a manner sufficient to improve the resolution of the particle in the region of analysis of the image, such as where the resolution of the particle in the region of analysis of the image is increased by 5% or more, such as by 10% or more, such as by 15% or more, such as by 25% or more, such as by 50% or more, such as by 75% or more, such as by 90% or more, such as by 95% or more, such as by 97% or more and including by increasing the pixel intensity threshold by 99% or more. In another example, the pixel intensity threshold is modulated in a manner sufficient to increase the visualization of subcellular components of cells in the region of analysis of the image, such as where the resolution of subcellular components of cells (e.g., intracellular vesicles such as the nucleus of the cell) in the image is increased by 5% or more, such as by 10% or more, such as by 15% or more, such as by 25% or more, such as by 50% or more, such as by 75% or more, such as by 90% or more, such as by 95% or more, such as by 97% or more and including by increasing the pixel intensity threshold by 99% or more. In another example, the pixel intensity threshold is modulated in a manner sufficient to increase the pixel brightness of cellular stain components in the region of analysis of the image, such as where the pixel brightness of cellular stain components in the image is increased by 5% or more, such as by 10% or more, such as by 15% or more, such as by 25% or more, such as by 50% or more, such as by 75% or more, such as by 90% or more, such as by 95% or more, such as by 97% or more and including by increasing the pixel intensity threshold by 99% or more.

In embodiments, systems include a processor having memory operably coupled to the processor where the memory includes instructions stored thereon, which when executed by the processor, cause the processor to automatically adjust a data acquisition parameter of the particle analyzer in response to a change in the visualization parameter for the particle image. In some instances, the memory includes instructions to make changes to the data acquisition parameters in real-time such as where modulation of the visualization parameter dynamically changes the data acquisition parameters. In certain instances, the memory includes instructions for changing to the data acquisition parameters immediately in conjunction with modulating the visualization parameter. In other instances, the memory includes instructions for changing to the data acquisition parameters after a predetermined duration after modulation of the visualization parameter. For example, changes to the data acquisition parameters of the particle analyzer may be delayed by 0.00001 seconds or more, such as by 0.00005 seconds or more, such as by 0.0001 seconds or more, such as by 0.0005 seconds or more, such as by 0.001 seconds or more, such as by 0.005 seconds or more, such as by 0.01 seconds or more, such as by 0.05 seconds or more, such as by 0.1 seconds or more, such as by 0.5 seconds or more, such as by 1 second or more, such as by 5 seconds or more, such as by 30 seconds or more, such as by 1 minute or more and including by 5 minutes or more. In some embodiments, the memory includes instructions for automatically adjusting the data acquisition parameters of the particle analyzer while light from the irradiated sample in the flow stream is being detected.

In some instances, the memory includes instructions for dynamically adjusting a light intensity detection threshold for one or more of the detector channels in real time in response to a change in the visualization parameter. For example, the memory may include instructions for automatically adjusting a light intensity threshold that is required to generate a data signal from one or more photodetector channels of the particle analyzer. In some instances, the memory includes instructions for adjusting an intensity threshold for generating a data signal in a scattered light photodetector channel (e.g., a forward scattered light detector channel or a side scattered light detector channel) in response to the modulated visualization parameter. In other instances, the memory includes instructions to automatically adjust an intensity threshold for generating a data signal in a fluorescence photodetector channel in response to the modulated visualization parameter. In other instances, the memory includes instructions to automatically adjust an intensity threshold for generating a data signal in a light loss photodetector channel in response to the modulated visualization parameter. In some instances, modulating the visualization parameter reduces the threshold intensity of light that generates a data signal from one or more photodetector channel by 0.1% or more, such as by 0.5% or more, such as by 1% or more, such as by 5% or more, such as by 10% or more, such as by 15% or more, such as by 25% or more, such as by 50% or more and including reducing the threshold intensity of light that generates a data signal from one or more photodetector channel by 75% or more. In certain instances, modulating the visualization parameter increases the threshold intensity of light that generates a data signal from one or more photodetector channel by 0.1% or more, such as by 0.5% or more, such as by 1% or more, such as by 5% or more, such as by 10% or more, such as by 15% or more, such as by 25% or more, such as by 50% or more and including increasing the threshold intensity of light that generates a data signal from one or more photodetector channel by 75% or more. In certain embodiments, the data acquisition parameter is a light intensity detection threshold for generating an image. In some instances, the memory includes instructions for generating an image of the particle when light detected in one or more of the detection channels exceeds the adjusted light intensity detection threshold. In other instances, the memory includes instructions for not generating an image when light detected in a light detection channel does not exceed the light intensity threshold.

In some embodiments, the memory includes instructions for adjusting an event detection threshold in response to the modulated visualization parameter. In some instances, the memory includes instructions for adjusting an event detection threshold in a forward scattered light detector channel. In some instances, the memory includes instructions for adjusting an event detection threshold in a side scattered light detector channel. In certain instances, memory includes instructions for adjusting an event detection threshold in a combination of a forward scattered light detector channel and a side scattered light detector channel. In some embodiments, modulating the visualization parameter reduces the threshold for event detection in the photodetector channel by 0.1% or more, such as by 0.5% or more, such as by 1% or more, such as by 5% or more, such as by 10% or more, such as by 15% or more, such as by 25% or more, such as by 50% or more and including reducing the event detection threshold by 75% or more. In certain instances, modulating the visualization parameter increases the threshold for event detection in the photodetector channel by 0.1% or more, such as by 0.5% or more, such as by 1% or more, such as by 5% or more, such as by 10% or more, such as by 15% or more, such as by 25% or more, such as by 50% or more and including increasing the threshold for event detection in the photodetector channel by 75% or more.

In some embodiments, systems include memory for expanding a sorting gate to increase the number of particles that are sorted in the sample in response to the modulated visualization parameter, such as where the population of particles gated for sorting is increased by 5% or more, such as by 10% or more, such as by 25% or more, such as by 50% or more and including where the population of particles gated for sorting is increased by 75% or more. In some instances, modulating the visualization parameter reduces the size of the sorting gate such that the population of particles gated for sorting is decreased by 5% or more, such as by 10% or more, such as by 25% or more, such as by 50% or more and including where the population of particles gated for sorting is decreased by 75% or more. In certain embodiments, modulating the visualization parameter provides for changing a sorting gate to be specific to a target population of particles in the sample, such as where particles of a sample that are gated to be sorted are of the same cell type (e.g., lymphocytes). In other embodiments, modulating the visualization parameter provides for changing a sorting gate to be specific for particles having the same size. In yet other embodiments, modulating the visualization parameter provides for changing a sorting gate to be specific for particles which exhibit the same fluorescence markers.

In certain embodiments, systems further include a flow cell configured to propagate the sample in the flow stream. Any convenient flow cell which propagates a fluidic sample to a sample interrogation region may be employed, where in some embodiments, the flow cell includes a proximal cylindrical portion defining a longitudinal axis and a distal frustoconical portion which terminates in a flat surface having the orifice that is transverse to the longitudinal axis. The length of the proximal cylindrical portion (as measured along the longitudinal axis) may vary ranging from 1 mm to 15 mm, such as from 1.5 mm to 12.5 mm, such as from 2 mm to 10 mm, such as from 3 mm to 9 mm and including from 4 mm to 8 mm. The length of the distal frustoconical portion (as measured along the longitudinal axis) may also vary, ranging from 1 mm to 10 mm, such as from 2 mm to 9 mm, such as from 3 mm to 8 mm and including from 4 mm to 7 mm. The diameter of the of the flow cell nozzle chamber may vary, in some embodiments, ranging from 1 mm to 10 mm, such as from 2 mm to 9 mm, such as from 3 mm to 8 mm and including from 4 mm to 7 mm.

In certain instances, the flow cell does not include a cylindrical portion and the entire flow cell inner chamber is frustoconically shaped. In these embodiments, the length of the frustoconical inner chamber (as measured along the longitudinal axis transverse to the nozzle orifice), may range from 1 mm to 15 mm, such as from 1.5 mm to 12.5 mm, such as from 2 mm to 10 mm, such as from 3 mm to 9 mm and including from 4 mm to 8 mm. The diameter of the proximal portion of the frustoconical inner chamber may range from 1 mm to 10 mm, such as from 2 mm to 9 mm, such as from 3 mm to 8 mm and including from 4 mm to 7 mm.

In some embodiments, the sample flow stream emanates from an orifice at the distal end of the flow cell. Depending on the desired characteristics of the flow stream, the flow cell orifice may be any suitable shape where cross-sectional shapes of interest include, but are not limited to: rectilinear cross sectional shapes, e.g., squares, rectangles, trapezoids, triangles, hexagons, etc., curvilinear cross-sectional shapes, e.g., circles, ovals, as well as irregular shapes, e.g., a parabolic bottom portion coupled to a planar top portion. In certain embodiments, flow cell of interest has a circular orifice. The size of the nozzle orifice may vary, in some embodiments ranging from 1 μm to 20000 μm such as from 2 μm to 17500 μm such as from 5 μm to 15000 μm such as from 10 μm to 12500 μm such as from 15 μm to 10000 μm such as from 25 μm to 7500 μm, such as from 50 μm to 5000 μm, such as from 75 μm to 1000 μm, such as from 100 μm to 750 μm and including from 150 μm to 500 μm. In certain embodiments, the nozzle orifice is 100 μm.

In some embodiments, the flow cell includes a sample injection port configured to provide a sample to the flow cell. In embodiments, the sample injection system is configured to provide suitable flow of sample to the flow cell inner chamber. Depending on the desired characteristics of the flow stream, the rate of sample conveyed to the flow cell chamber by the sample injection port may be 1 μL/min or more, such as 2 μL/min or more, such as 3 μL/min or more, such as 5 μL/min or more, such as 10 μL/min or more, such as 15 μL/min or more, such as 25 μL/min or more, such as 50 μL/min or more and including 100 μL/min or more, where in some instances the rate of sample conveyed to the flow cell chamber by the sample injection port is 14/sec or more, such as 2 μL/sec or more, such as 3 μL/sec or more, such as 5 μL/sec or more, such as 10 μL/sec or more, such as 15 μL/sec or more, such as 25 μL/sec or more, such as 50 μL/sec or more and including 100 μL/sec or more.

The sample injection port may be an orifice positioned in a wall of the inner chamber or may be a conduit positioned at the proximal end of the inner chamber. Where the sample injection port is an orifice positioned in a wall of the inner chamber, the sample injection port orifice may be any suitable shape where cross-sectional shapes of interest include, but are not limited to: rectilinear cross sectional shapes, e.g., squares, rectangles, trapezoids, triangles, hexagons, etc., curvilinear cross-sectional shapes, e.g., circles, ovals, etc., as well as irregular shapes, e.g., a parabolic bottom portion coupled to a planar top portion. In certain embodiments, the sample injection port has a circular orifice. The size of the sample injection port orifice may vary depending on shape, in certain instances, having an opening ranging from 0.1 mm to 5.0 mm, e.g., 0.2 to 3.0 mm, e.g., 0.5 mm to 2.5 mm, such as from 0.75 mm to 2.25 mm, such as from 1 mm to 2 mm and including from 1.25 mm to 1.75 mm, for example 1.5 mm.

In certain instances, the sample injection port is a conduit positioned at a proximal end of the flow cell inner chamber. For example, the sample injection port may be a conduit positioned to have the orifice of the sample injection port in line with the flow cell orifice. Where the sample injection port is a conduit positioned in line with the flow cell orifice, the cross-sectional shape of the sample injection tube may be any suitable shape where cross-sectional shapes of interest include, but are not limited to: rectilinear cross sectional shapes, e.g., squares, rectangles, trapezoids, triangles, hexagons, etc., curvilinear cross-sectional shapes, e.g., circles, ovals, as well as irregular shapes, e.g., a parabolic bottom portion coupled to a planar top portion. The orifice of the conduit may vary depending on shape, in certain instances, having an opening ranging from 0.1 mm to 5.0 mm, e.g., 0.2 to 3.0 mm, e.g., 0.5 mm to 2.5 mm, such as from 0.75 mm to 2.25 mm, such as from 1 mm to 2 mm and including from 1.25 mm to 1.75 mm, for example 1.5 mm. The shape of the tip of the sample injection port may be the same or different from the cross-section shape of the sample injection tube. For example, the orifice of the sample injection port may include a beveled tip having a bevel angle ranging from 1° to 10°, such as from 2° to 9°, such as from 3° to 8°, such as from 4° to 7° and including a bevel angle of 5°.

In some embodiments, the flow cell also includes a sheath fluid injection port configured to provide a sheath fluid to the flow cell. In embodiments, the sheath fluid injection system is configured to provide a flow of sheath fluid to the flow cell inner chamber, for example in conjunction with the sample to produce a laminated flow stream of sheath fluid surrounding the sample flow stream. Depending on the desired characteristics of the flow stream, the rate of sheath fluid conveyed to the flow cell chamber by the may be 254/sec or more, such as 50 μL/sec or more, such as 75 μL/sec or more, such as 100 μL/sec or more, such as 250 μL/sec or more, such as 500 μL/sec or more, such as 750 μL/sec or more, such as 1000 μL/sec or more and including 2500 μL/sec or more.

In some embodiments, the sheath fluid injection port is an orifice positioned in a wall of the inner chamber. The sheath fluid injection port orifice may be any suitable shape where cross-sectional shapes of interest include, but are not limited to: rectilinear cross-sectional shapes, e.g., squares, rectangles, trapezoids, triangles, hexagons, etc., curvilinear cross-sectional shapes, e.g., circles, ovals, as well as irregular shapes, e.g., a parabolic bottom portion coupled to a planar top portion. The size of the sample injection port orifice may vary depending on shape, in certain instances, having an opening ranging from 0.1 mm to 5.0 mm, e.g., 0.2 to 3.0 mm, e.g., 0.5 mm to 2.5 mm, such as from 0.75 mm to 2.25 mm, such as from 1 mm to 2 mm and including from 1.25 mm to 1.75 mm, for example 1.5 mm.

In some embodiments, systems further include a pump in fluid communication with the flow cell to propagate the flow stream through the flow cell. Any convenient fluid pump protocol may be employed to control the flow of the flow stream through the flow cell. In certain instances, systems include a peristaltic pump, such as a peristaltic pump having a pulse damper. The pump in the subject systems is configured to convey fluid through the flow cell at a rate suitable for detecting light from the sample in the flow stream. In some instances, the rate of sample flow in the flow cell is 1 μL/min (microliter per minute) or more, such as 2 μL/min or more, such as 3 μL/min or more, such as 5 μL/min or more, such as 10 μL/min or more, such as 25 μL/min or more, such as 50 μL/min or more, such as 75 μL/min or more, such as 100 μL/min or more, such as 250 μL/min or more, such as 500 μL/min or more, such as 750 μL/min or more and including 1000 μL/min or more. For example, the system may include a pump that is configured to flow sample through the flow cell at a rate that ranges from 1 μL/min to 500 μL/min, such as from 1 μL/min to 250 μL/min, such as from 1 μL/min to 100 μL/min, such as from 2 μL/min to 90 μL/min, such as from 3 μL/min to 80 μL/min, such as from 4 μL/min to 70 μL/min, such as from 5 μL/min to 60 μL/min and including rom 10 μL/min to 50 μL/min. In certain embodiments, the flow rate of the flow stream is from 5 μL/min to 6 μL/min.

In certain embodiments, light detection systems having the plurality of photodetectors as described above are part of or positioned in a particle analyzer, such as a particle sorter. In certain embodiments, the subject systems are flow cytometric systems that includes the photodiode and amplifier component as part of a light detection system for detecting light emitted by a sample in a flow stream. Suitable flow cytometry systems may include, but are not limited to, those described in Ormerod (ed.), Flow Cytometry: A Practical Approach, Oxford Univ. Press (1997); Jaroszeski et al. (eds.), Flow Cytometry Protocols, Methods in Molecular Biology No. 91, Humana Press (1997); Practical Flow Cytometry, 3rd ed., Wiley-Liss (1995); Virgo, et al. (2012) Ann Clin Biochem. January; 49(pt 1):17-28; Linden, et. al., Semin Throm Hemost. 2004 October; 30(5):502-11; Alison, et al. J Pathol, 2010 December; 222(4):335-344; and Herbig, et al. (2007) Crit Rev Ther Drug Carrier Syst. 24(3):203-255; the disclosures of which are incorporated herein by reference. In certain instances, flow cytometry systems of interest include BD Biosciences FACSCanto™ flow cytometer, BD Biosciences FACSCanto™ II flow cytometer, BD Accuri™ flow cytometer, BD Accuri™ C6 Plus flow cytometer, BD Biosciences FACSCelesta™ flow cytometer, BD Biosciences FACSLyric™ flow cytometer, BD Biosciences FACSVerse™ flow cytometer, BD Biosciences FACSymphony™ flow cytometer, BD Biosciences LSRFortessa™ flow cytometer, BD Biosciences LSRFortessa™ X-20 flow cytometer, BD Biosciences FACSPresto™ flow cytometer, BD Biosciences FACSVia™ flow cytometer and BD Biosciences FACSCalibur™ cell sorter, a BD Biosciences FACSCount™ cell sorter, BD Biosciences FACSLyric™ cell sorter, BD Biosciences Via™ cell sorter, BD Biosciences Influx™ cell sorter, BD Biosciences Jazz™ cell sorter, BD Biosciences Aria™ cell sorter, BD Biosciences FACSAria™ II cell sorter, BD Biosciences FACSAria™ III cell sorter, BD Biosciences FACSAria™ Fusion cell sorter and BD Biosciences FACSMelody™ cell sorter, BD Biosciences FACSymphony™ S6 cell sorter or the like.

In some embodiments, the subject systems are flow cytometric systems, such those described in U.S. Pat. Nos. 10,663,476; 10,620,111; 10,613,017; 10,605,713; 10,585,031; 10,578,542; 10,578,469; 10,481,074; 10,302,545; 10,145,793; 10,113,967; 10,006,852; 9,952,076; 9,933,341; 9,726,527; 9,453,789; 9,200,334; 9,097,640; 9,095,494; 9,092,034; 8,975,595; 8,753,573; 8,233,146; 8,140,300; 7,544,326; 7,201,875; 7,129,505; 6,821,740; 6,813,017; 6,809,804; 6,372,506; 5,700,692; 5,643,796; 5,627,040; 5,620,842; 5,602,039; 4,987,086; 4,498,766; the disclosures of which are herein incorporated by reference in their entirety.

In some embodiments, the subject systems are particle sorting systems that are configured to sort particles with an enclosed particle sorting module, such as those described in U.S. Patent Publication No. 2017/0299493, the disclosure of which is incorporated herein by reference. In certain embodiments, particles (e.g, cells) of the sample are sorted using a sort decision module having a plurality of sort decision units, such as those described in U.S. Patent Publication No. 2020/0256781, the disclosure of which is incorporated herein by reference. In some embodiments, the subject systems include a particle sorting module having deflector plates, such as described in U.S. Patent Publication No. 2017/0299493, filed on Mar. 28, 2017, the disclosure of which is incorporated herein by reference.

In certain instances, flow cytometry systems of the invention are configured for imaging particles in a flow stream by fluorescence imaging using radiofrequency tagged emission (FIRE), such as those described in Diebold, et al. Nature Photonics Vol. 7(10); 806-810 (2013) as well as described in U.S. Pat. Nos. 9,423,353; 9,784,661; 9,983,132; 10,006,852; 10,078,045; 10,036,699; 10,222,316; 10,288,546; 10,324,019; 10,408,758; 10,451,538; 10,620,111; and U.S. Patent Publication Nos. 2017/0133857; 2017/0328826; 2017/0350803; 2018/0275042; 2019/0376895 and 2019/0376894 the disclosures of which are herein incorporated by reference.

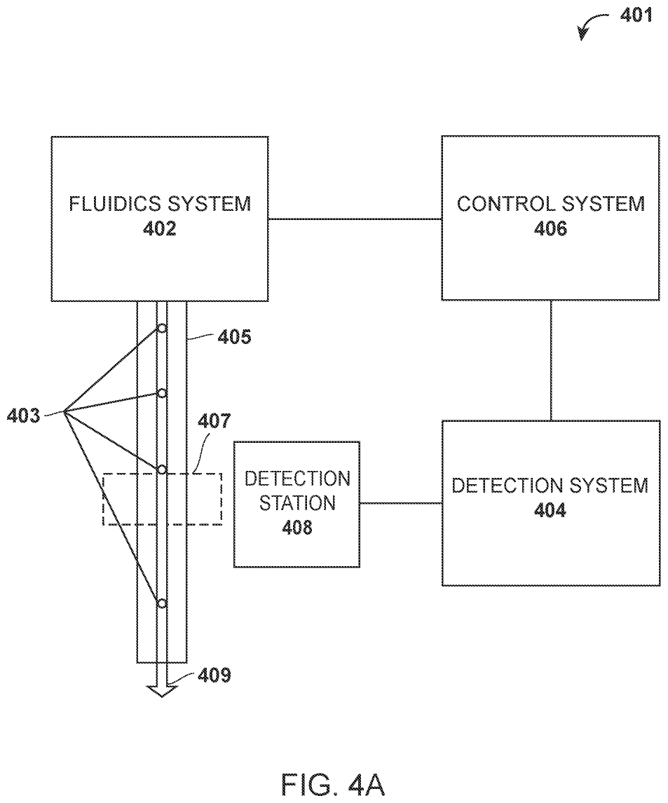

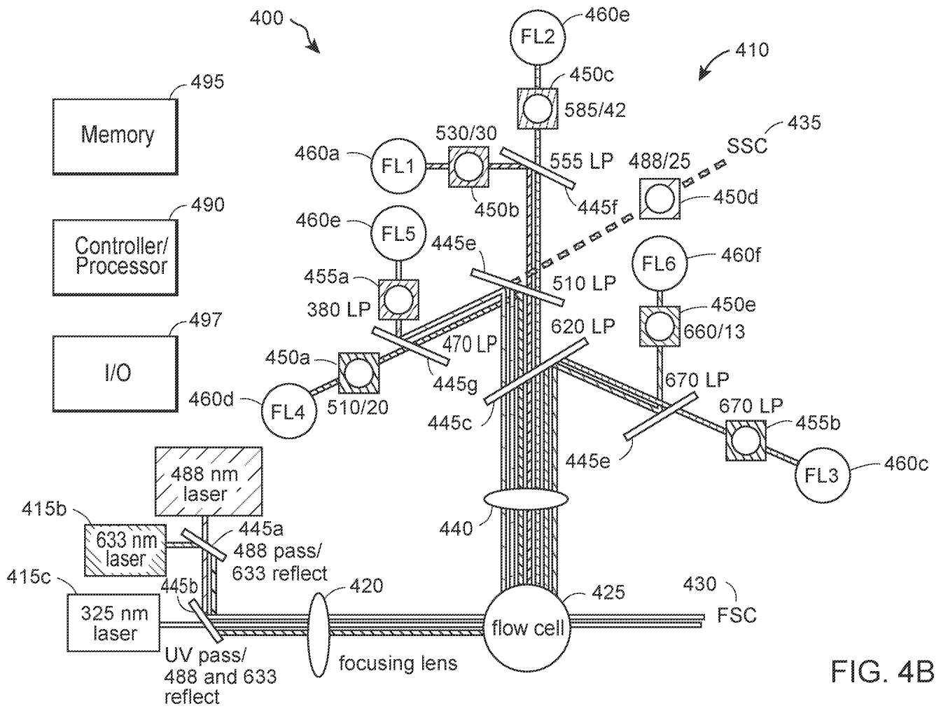

In some embodiments, systems are particle analyzers where the particle analysis system 401 (FIG. 4A) can be used to analyze and characterize particles, with or without physically sorting the particles into collection vessels. FIG. 4A shows a functional block diagram of a particle analysis system for computational based sample analysis and particle characterization. In some embodiments, the particle analysis system 401 is a flow system. The particle analysis system 401 shown in FIG. 4A can be configured to perform, in whole or in part, the methods described herein such as. The particle analysis system 401 includes a fluidics system 402. The fluidics system 402 can include or be coupled with a sample tube 405 and a moving fluid column within the sample tube in which particles 403 (e.g. cells) of a sample move along a common sample path 409.

The particle analysis system 401 includes a detection system 404 configured to collect a signal from each particle as it passes one or more detection stations along the common sample path. A detection station 408 generally refers to a monitored area 407 of the common sample path. Detection can, in some implementations, include detecting light or one or more other properties of the particles 403 as they pass through a monitored area 407. In FIG. 4A, one detection station 408 with one monitored area 407 is shown. Some implementations of the particle analysis system 401 can include multiple detection stations. Furthermore, some detection stations can monitor more than one area.

Each signal is assigned a signal value to form a data point for each particle. As described above, this data can be referred to as event data. The data point can be a multidimensional data point including values for respective properties measured for a particle. The detection system 404 is configured to collect a succession of such data points in a first-time interval.

The particle analysis system 401 can also include a control system 306. The control system 406 can include one or more processors, an amplitude control circuit and/or a frequency control circuit. The control system shown can be operationally associated with the fluidics system 402. The control system can be configured to generate a calculated signal frequency for at least a portion of the first-time interval based on a Poisson distribution and the number of data points collected by the detection system 404 during the first time interval. The control system 406 can be further configured to generate an experimental signal frequency based on the number of data points in the portion of the first time interval. The control system 406 can additionally compare the experimental signal frequency with that of a calculated signal frequency or a predetermined signal frequency.

FIG. 4B shows a system 400 for flow cytometry in accordance with an illustrative embodiment of the present invention. The system 400 includes a flow cytometer 410, a controller/processor 490 and a memory 495. The flow cytometer 410 includes one or more excitation lasers 415a-415c, a focusing lens 420, a flow chamber 425, a forward scatter detector 430, a side scatter detector 435, a fluorescence collection lens 440, one or more beam splitters 445a-445g, one or more bandpass filters 450a-450e, one or more longpass (“LP”) filters 455a-455b, and one or more fluorescent detectors 460a-460f.

The excitation lasers 115a-c emit light in the form of a laser beam. The wavelengths of the laser beams emitted from excitation lasers 415a-415c are 488 nm, 633 nm, and 325 nm, respectively, in the example system of FIG. 4B. The laser beams are first directed through one or more of beam splitters 445a and 445b. Beam splitter 445a transmits light at 488 nm and reflects light at 633 nm. Beam splitter 445b transmits UV light (light with a wavelength in the range of 10 to 400 nm) and reflects light at 488 nm and 633 nm.

The laser beams are then directed to a focusing lens 420, which focuses the beams onto the portion of a fluid stream where particles of a sample are located, within the flow chamber 425. The flow chamber is part of a fluidics system which directs particles, typically one at a time, in a stream to the focused laser beam for interrogation. The flow chamber can comprise a flow cell in a benchtop cytometer or a nozzle tip in a stream-in-air cytometer.

The light from the laser beam(s) interacts with the particles in the sample by diffraction, refraction, reflection, scattering, and absorption with re-emission at various different wavelengths depending on the characteristics of the particle such as its size, internal structure, and the presence of one or more fluorescent molecules attached to or naturally present on or in the particle. The fluorescence emissions as well as the diffracted light, refracted light, reflected light, and scattered light may be routed to one or more of the forward scatter detector 430, the side scatter detector 435, and the one or more fluorescent detectors 460a-460f through one or more of the beam splitters 445a-445g, the bandpass filters 450a-450e, the longpass filters 455a-455b, and the fluorescence collection lens 440.

The fluorescence collection lens 440 collects light emitted from the particle-laser beam interaction and routes that light towards one or more beam splitters and filters. Bandpass filters, such as bandpass filters 450a-450e, allow a narrow range of wavelengths to pass through the filter. For example, bandpass filter 450a is a 510/20 filter. The first number represents the center of a spectral band. The second number provides a range of the spectral band. Thus, a 510/20 filter extends 10 nm on each side of the center of the spectral band, or from 500 nm to 520 nm. Shortpass filters transmit wavelengths of light equal to or shorter than a specified wavelength. Longpass filters, such as longpass filters 455a-455b, transmit wavelengths of light equal to or longer than a specified wavelength of light. For example, longpass filter 455a, which is a 670 nm longpass filter, transmits light equal to or longer than 670 nm. Filters are often selected to optimize the specificity of a detector for a particular fluorescent dye. The filters can be configured so that the spectral band of light transmitted to the detector is close to the emission peak of a fluorescent dye.

Beam splitters direct light of different wavelengths in different directions. Beam splitters can be characterized by filter properties such as shortpass and longpass. For example, beam splitter 445g is a 620 SP beam splitter, meaning that the beam splitter 445g transmits wavelengths of light that are 620 nm or shorter and reflects wavelengths of light that are longer than 620 nm in a different direction. In one embodiment, the beam splitters 445a-445g can comprise optical mirrors, such as dichroic mirrors.

The forward scatter detector 430 is positioned slightly off axis from the direct beam through the flow cell and is configured to detect diffracted light, the excitation light that travels through or around the particle in mostly a forward direction. The intensity of the light detected by the forward scatter detector is dependent on the overall size of the particle. The forward scatter detector can include a photodiode. The side scatter detector 435 is configured to detect refracted and reflected light from the surfaces and internal structures of the particle, and tends to increase with increasing particle complexity of structure. The fluorescence emissions from fluorescent molecules associated with the particle can be detected by the one or more fluorescent detectors 460a-460f. The side scatter detector 435 and fluorescent detectors can include photomultiplier tubes. The signals detected at the forward scatter detector 430, the side scatter detector 435 and the fluorescent detectors can be converted to electronic signals (voltages) by the detectors. This data can provide information about the sample.

One of skill in the art will recognize that a flow cytometer in accordance with an embodiment of the present invention is not limited to the flow cytometer depicted in FIG. 4B, but can include any flow cytometer known in the art. For example, a flow cytometer may have any number of lasers, beam splitters, filters, and detectors at various wavelengths and in various different configurations.

In operation, cytometer operation is controlled by a controller/processor 490, and the measurement data from the detectors can be stored in the memory 495 and processed by the controller/processor 490. Although not shown explicitly, the controller/processor 190 is coupled to the detectors to receive the output signals therefrom, and may also be coupled to electrical and electromechanical components of the flow cytometer 400 to control the lasers, fluid flow parameters, and the like. Input/output (I/O) capabilities 497 may be provided also in the system. The memory 495, controller/processor 490, and I/O 497 may be entirely provided as an integral part of the flow cytometer 410. In such an embodiment, a display may also form part of the I/O capabilities 497 for presenting experimental data to users of the cytometer 400. Alternatively, some or all of the memory 495 and controller/processor 490 and I/O capabilities may be part of one or more external devices such as a general purpose computer. In some embodiments, some or all of the memory 495 and controller/processor 490 can be in wireless or wired communication with the cytometer 410. The controller/processor 490 in conjunction with the memory 495 and the I/O 497 can be configured to perform various functions related to the preparation and analysis of a flow cytometer experiment.

The system illustrated in FIG. 4B includes six different detectors that detect fluorescent light in six different wavelength bands (which may be referred to herein as a “filter window” for a given detector) as defined by the configuration of filters and/or splitters in the beam path from the flow cell 425 to each detector. Different fluorescent molecules used for a flow cytometer experiment will emit light in their own characteristic wavelength bands. The particular fluorescent labels used for an experiment and their associated fluorescent emission bands may be selected to generally coincide with the filter windows of the detectors. However, as more detectors are provided, and more labels are utilized, perfect correspondence between filter windows and fluorescent emission spectra is not possible. It is generally true that although the peak of the emission spectra of a particular fluorescent molecule may lie within the filter window of one particular detector, some of the emission spectra of that label will also overlap the filter windows of one or more other detectors. This may be referred to as spillover. The I/O 497 can be configured to receive data regarding a flow cytometer experiment having a panel of fluorescent labels and a plurality of cell populations having a plurality of markers, each cell population having a subset of the plurality of markers. The I/O 497 can also be configured to receive biological data assigning one or more markers to one or more cell populations, marker density data, emission spectrum data, data assigning labels to one or more markers, and cytometer configuration data. Flow cytometer experiment data, such as label spectral characteristics and flow cytometer configuration data can also be stored in the memory 495. The controller/processor 490 can be configured to evaluate one or more assignments of labels to markers.

FIG. 5 shows a functional block diagram for one example of a particle analyzer control system, such as an analytics controller 500, for analyzing and displaying biological events. An analytics controller 500 can be configured to implement a variety of processes for controlling graphic display of biological events.

A particle analyzer or sorting system 502 can be configured to acquire biological event data. For example, a flow cytometer can generate flow cytometric event data. The particle analyzer 502 can be configured to provide biological event data to the analytics controller 500. A data communication channel can be included between the particle analyzer or sorting system 502 and the analytics controller 500. The biological event data can be provided to the analytics controller 500 via the data communication channel.

The analytics controller 500 can be configured to receive biological event data from the particle analyzer or sorting system 502. The biological event data received from the particle analyzer or sorting system 502 can include flow cytometric event data. The analytics controller 500 can be configured to provide a graphical display including a first plot of biological event data to a display device 506. The analytics controller 500 can be further configured to render a region of interest as a gate around a population of biological event data shown by the display device 506, overlaid upon the first plot, for example. In some embodiments, the gate can be a logical combination of one or more graphical regions of interest drawn upon a single parameter histogram or bivariate plot. In some embodiments, the display can be used to display particle parameters or saturated detector data.

The analytics controller 500 can be further configured to display the biological event data on the display device 506 within the gate differently from other events in the biological event data outside of the gate. For example, the analytics controller 500 can be configured to render the color of biological event data contained within the gate to be distinct from the color of biological event data outside of the gate. The display device 506 can be implemented as a monitor, a tablet computer, a smartphone, or other electronic device configured to present graphical interfaces.

The analytics controller 500 can be configured to receive a gate selection signal identifying the gate from a first input device. For example, the first input device can be implemented as a mouse 510. The mouse 510 can initiate a gate selection signal to the analytics controller 500 identifying the gate to be displayed on or manipulated via the display device 506 (e.g., by clicking on or in the desired gate when the cursor is positioned there). In some implementations, the first device can be implemented as the keyboard 508 or other means for providing an input signal to the analytics controller 500 such as a touchscreen, a stylus, an optical detector, or a voice recognition system. Some input devices can include multiple inputting functions. In such implementations, the inputting functions can each be considered an input device. For example, as shown in FIG. 5, the mouse 510 can include a right mouse button and a left mouse button, each of which can generate a triggering event.

The triggering event can cause the analytics controller 500 to alter the manner in which the data is displayed, which portions of the data is actually displayed on the display device 506, and/or provide input to further processing such as selection of a population of interest for particle sorting.

In some embodiments, the analytics controller 500 can be configured to detect when gate selection is initiated by the mouse 510. The analytics controller 500 can be further configured to automatically modify plot visualization to facilitate the gating process. The modification can be based on the specific distribution of biological event data received by the analytics controller 500.

The analytics controller 500 can be connected to a storage device 504. The storage device 504 can be configured to receive and store biological event data from the analytics controller 500. The storage device 504 can also be configured to receive and store flow cytometric event data from the analytics controller 500. The storage device 504 can be further configured to allow retrieval of biological event data, such as flow cytometric event data, by the analytics controller 500.

A display device 506 can be configured to receive display data from the analytics controller 500. The display data can comprise plots of biological event data and gates outlining sections of the plots. The display device 506 can be further configured to alter the information presented according to input received from the analytics controller 500 in conjunction with input from the particle analyzer 502, the storage device 504, the keyboard 508, and/or the mouse 510.

In some implementations, the analytics controller 500 can generate a user interface to receive example events for sorting. For example, the user interface can include a control for receiving example events or example images. The example events or images or an example gate can be provided prior to collection of event data for a sample, or based on an initial set of events for a portion of the sample.

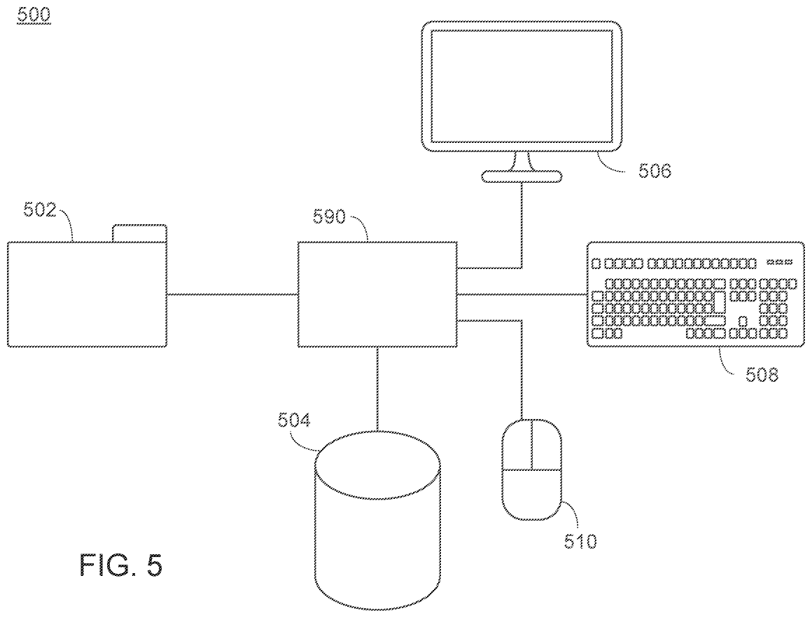

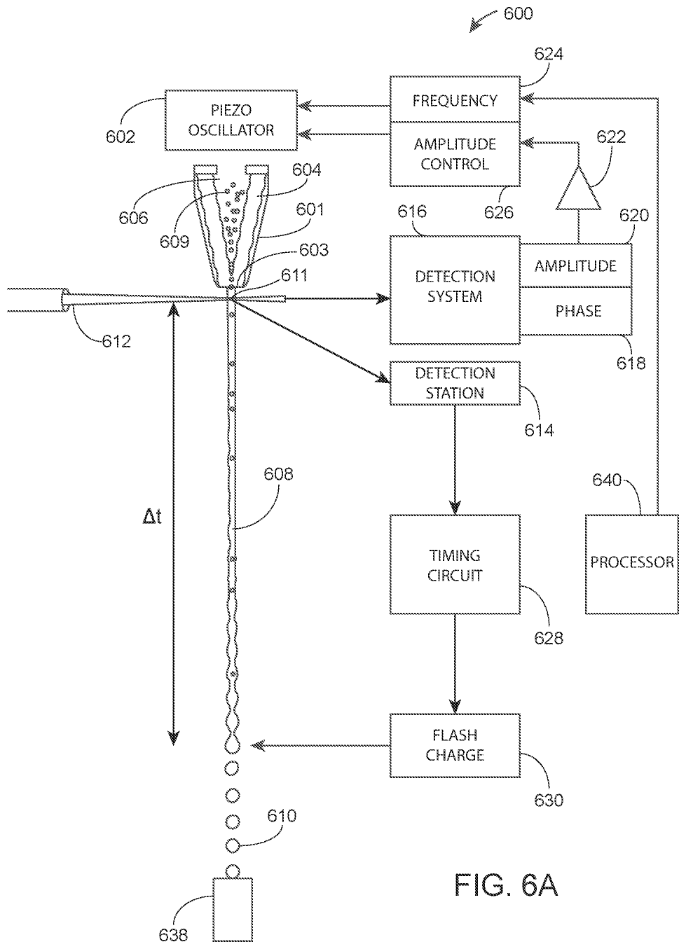

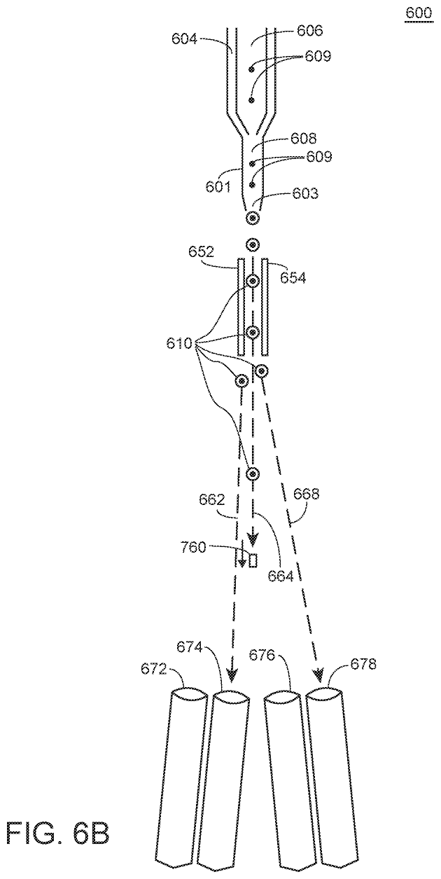

FIG. 6A is a schematic drawing of a particle sorter system 600 (e.g., the particle analyzer or sorting system 502) in accordance with one embodiment presented herein. In some embodiments, the particle sorter system 600 is a cell sorter system. As shown in FIG. 6A, a drop formation transducer 602 (e.g., piezo-oscillator) is coupled to a fluid conduit 601, which can be coupled to, can include, or can be, a nozzle 603. Within the fluid conduit 601, sheath fluid 604 hydrodynamically focuses a sample fluid 606 comprising particles 609 into a moving fluid column 608 (e.g., a stream). Within the moving fluid column 608, particles 609 (e.g., cells) are lined up in single file to cross a monitored area 611 (e.g., where laser-stream intersect), irradiated by an irradiation source 612 (e.g., a laser). Vibration of the drop formation transducer 602 causes moving fluid column 608 to break into a plurality of drops 610, some of which contain particles 609.

In operation, a detection station 614 (e.g., an event detector) identifies when a particle of interest (or cell of interest) crosses the monitored area 611. Detection station 614 feeds into a timing circuit 628, which in turn feeds into a flash charge circuit 630. At a drop break off point, informed by a timed drop delay (at), a flash charge can be applied to the moving fluid column 608 such that a drop of interest carries a charge. The drop of interest can include one or more particles or cells to be sorted. The charged drop can then be sorted by activating deflection plates (not shown) to deflect the drop into a vessel such as a collection tube or a multi-well or microwell sample plate where a well or microwell can be associated with drops of particular interest. As shown in FIG. 6A, the drops can be collected in a drain receptacle 638.

A detection system 616 (e.g., a drop boundary detector) serves to automatically determine the phase of a drop drive signal when a particle of interest passes the monitored area 611. An exemplary drop boundary detector is described in U.S. Pat. No. 7,679,039, which is incorporated herein by reference in its entirety. The detection system 616 allows the instrument to accurately calculate the place of each detected particle in a drop. The detection system 616 can feed into an amplitude signal 620 and/or phase 618 signal, which in turn feeds (via amplifier 622) into an amplitude control circuit 626 and/or frequency control circuit 624. The amplitude control circuit 626 and/or frequency control circuit 624, in turn, controls the drop formation transducer 602. The amplitude control circuit 626 and/or frequency control circuit 624 can be included in a control system.

In some implementations, sort electronics (e.g., the detection system 616, the detection station 614 and a processor 640) can be coupled with a memory configured to store the detected events and a sort decision based thereon. The sort decision can be included in the event data for a particle. In some implementations, the detection system 616 and the detection station 614 can be implemented as a single detection unit or communicatively coupled such that an event measurement can be collected by one of the detection system 616 or the detection station 614 and provided to the non-collecting element.

FIG. 6B is a schematic drawing of a particle sorter system, in accordance with one embodiment presented herein. The particle sorter system 600 shown in FIG. 6B, includes deflection plates 652 and 654. A charge can be applied via a stream-charging wire in a barb. This creates a stream of droplets 610 containing particles 610 for analysis. The particles can be illuminated with one or more light sources (e.g., lasers) to generate light scatter and fluorescence information. The information for a particle is analyzed such as by sorting electronics or other detection system (not shown in FIG. 6B). The deflection plates 652 and 654 can be independently controlled to attract or repel the charged droplet to guide the droplet toward a destination collection receptacle (e.g., one of 672, 674, 676, or 678). As shown in FIG. 6B, the deflection plates 652 and 654 can be controlled to direct a particle along a first path 662 toward the receptacle 674 or along a second path 668 toward the receptacle 678. If the particle is not of interest (e.g., does not exhibit scatter or illumination information within a specified sort range), deflection plates may allow the particle to continue along a flow path 664. Such uncharged droplets may pass into a waste receptacle such as via aspirator 670.

The sorting electronics can be included to initiate collection of measurements, receive fluorescence signals for particles, and determine how to adjust the deflection plates to cause sorting of the particles. Example implementations of the embodiment shown in FIG. 6B include the BD FACSAria™ line of flow cytometers commercially provided by Becton, Dickinson and Company (Franklin Lakes, N.J.).

### Computer-Controlled Systems

Aspects of the present disclosure further include computer-controlled systems, where the systems further include one or more computers for complete automation or partial automation of the methods described herein. In some embodiments, systems include a computer having a computer readable storage medium with a computer program stored thereon, where the computer program when loaded on the computer includes instructions for detecting light from a particle of a sample in a flow stream irradiated with a light source, instructions for generating an image of each particle based on the detected light and algorithm for automatically adjusting a data acquisition parameter of the particle analyzer in response to a modulated visualization parameter for the image of the particle.

In some embodiments, the computer program includes instructions for generating an image of a particle, such as one or more frequency-encoded images of the particle based on data signals from the light detection system. In some instances, the computer program includes instructions for generating the image of the particle based on data signals from scattered light detector channels (e.g., forward scatter image data, side scatter image data). In other instances, the non-computer program includes instructions for generating the image of the particle based on data signals from one or more fluorescence detector channels. In other instances, the computer program includes instructions for generating the image of the particle based on data signals from one or more light loss detector channels. In still other instances, the computer program includes instructions for generating the image of the particle based on data signals from a combination of data signals from two or more of light scatter detector channels, fluorescence detector channels and light loss detector channels.

In some instances, the computer program includes instructions for modulating a visualization parameter of the image. In some instances, the computer program includes instructions for modulating the visualization parameter for a region of analysis of the image. In some instances, the computer program includes instructions for modulating a visualization threshold for the particle in the image. In certain instances, the computer program includes instructions for modulating the visualization parameter in the region of analysis sufficient to visualize a border of the particle in the image. In some embodiments, the computer program includes instructions for modulating visualization parameters of two or more particle images are modulated simultaneously.

In some instances, the computer program includes instructions for modulating a pixel intensity threshold. In certain instances, the computer program includes instructions for modulating the pixel intensity threshold for one or more detector channels. In some embodiments, the computer program includes instructions for modulating the pixel intensity threshold for a scattered light detector channel (e.g., side-scatter or forward-scatter) and a fluorescence light detector channel. In other instances, the computer program includes instructions for modulating the pixel intensity threshold for a scattered light detector channel and two or more fluorescence light detector channel. In certain instances, the detection parameter is a threshold for light intensity at each pixel location in the region of analysis. In some instances, the computer program includes instructions for modulating the pixel intensity threshold for a scattered light detector channel (e.g., side-scatter or forward-scatter) and a fluorescence light detector channel. In certain instances, the computer program includes instructions for modulating a pixel intensity threshold for a forward scattered light detector channel and a fluorescence light detector channel. In certain instances, the computer program includes instructions for modulating a pixel intensity threshold for a side scattered light detector channel and a fluorescence light detector channel.

In certain embodiments, the computer program includes instructions for modulating a visualization parameter when the pixel intensity in two or more detector channels exceeds or does not exceed a predetermined threshold according to a logic selected from:

| | | | |
|---|---|---|---|
| A and B | A or B | A and NOT B | NOT A and B |
| NOT A and NOT | NOT A or B | A or NOT B | A xor B |
| B | | | |
| NOT A or NOT | NOT A xor B | A xor NOT B | NOT A xor NOT |
| B | | | B |

where A and B are independently selected from a forward-scattered light detector channel (FSC); a side-scattered light detector channel (SSC); a fluorescence light detector channel (FL); and a light-loss detector channel (LL).

In embodiments, the computer program includes instructions for automatically adjusting a data acquisition parameter in response to a change in the visualization parameter for the particle image. In some embodiments, the computer program includes instructions for automatically adjusting data acquisition parameters of the particle analyzer while light from the irradiated sample in the flow stream is being detected. In some instances, the computer program includes instructions for dynamically adjusting a light intensity detection threshold for one or more of the detector channels in real time in response to a change in the visualization parameter. In some embodiments, the computer program includes instructions for applying the change to the data acquisition parameter to data signals generated in one or more non-imaging photodetector channels of the light detection system.

In some embodiments, the data acquisition parameter is a light intensity detection threshold for generating an image. In some instances, the computer program includes instructions for generating an image of the particle when light detected in one or more of the detection channels (e.g., a side scattered light detection channel) exceeds the adjusted light intensity detection threshold. In other instances, the computer program includes instructions for not generating an image of the particle when light detected in a light detection channel does not exceed the light intensity threshold. In some instances, the computer program includes instructions for automatically adjusting a sorting parameter for the particle analyzer in response to a change in the visualization parameter. In certain instances, the computer program includes instructions for dynamically adjusting in real time a sorting gate for one or more particle populations in the sample in response to a change in a visualization parameter for a particle image.

In embodiments, the system includes an input module, a processing module and an output module. The subject systems may include both hardware and software components, where the hardware components may take the form of one or more platforms, e.g., in the form of servers, such that the functional elements, i.e., those elements of the system that carry out specific tasks (such as managing input and output of information, processing information, etc.) of the system may be carried out by the execution of software applications on and across the one or more computer platforms represented of the system.

Systems may include a display and operator input device. Operator input devices may, for example, be a keyboard, mouse, or the like. The processing module includes a processor which has access to a memory having instructions stored thereon for performing the steps of the subject methods. The processing module may include an operating system, a graphical user interface (GUI) controller, a system memory, memory storage devices, and input-output controllers, cache memory, a data backup unit, and many other devices. The processor may be a commercially available processor or it may be one of other processors that are or will become available. The processor executes the operating system and the operating system interfaces with firmware and hardware in a well-known manner, and facilitates the processor in coordinating and executing the functions of various computer programs that may be written in a variety of programming languages, such as Java, Perl, C++, other high level or low level languages, as well as combinations thereof, as is known in the art. The operating system, typically in cooperation with the processor, coordinates and executes functions of the other components of the computer. The operating system also provides scheduling, input-output control, file and data management, memory management, and communication control and related services, all in accordance with known techniques. The processor may be any suitable analog or digital system. In some embodiments, processors include analog electronics which allows the user to manually align a light source with the flow stream based on the first and second light signals. In some embodiments, the processor includes analog electronics which provide feedback control, such as for example negative feedback control.

The system memory may be any of a variety of known or future memory storage devices. Examples include any commonly available random access memory (RAM), magnetic medium such as a resident hard disk or tape, an optical medium such as a read and write compact disc, flash memory devices, or other memory storage device. The memory storage device may be any of a variety of known or future devices, including a compact disk drive, a tape drive, a removable hard disk drive, or a diskette drive. Such types of memory storage devices typically read from, and/or write to, a program storage medium (not shown) such as, respectively, a compact disk, magnetic tape, removable hard disk, or floppy diskette. Any of these program storage media, or others now in use or that may later be developed, may be considered a computer program product. As will be appreciated, these program storage media typically store a computer software program and/or data. Computer software programs, also called computer control logic, typically are stored in system memory and/or the program storage device used in conjunction with the memory storage device.

In some embodiments, a computer program product is described comprising a computer usable medium having control logic (computer software program, including program code) stored therein. The control logic, when executed by the processor the computer, causes the processor to perform functions described herein. In other embodiments, some functions are implemented primarily in hardware using, for example, a hardware state machine. Implementation of the hardware state machine so as to perform the functions described herein will be apparent to those skilled in the relevant arts.

Memory may be any suitable device in which the processor can store and retrieve data, such as magnetic, optical, or solid-state storage devices (including magnetic or optical disks or tape or RAM, or any other suitable device, either fixed or portable). The processor may include a general-purpose digital microprocessor suitably programmed from a computer readable medium carrying necessary program code. Programming can be provided remotely to processor through a communication channel, or previously saved in a computer program product such as memory or some other portable or fixed computer readable storage medium using any of those devices in connection with memory. For example, a magnetic or optical disk may carry the programming, and can be read by a disk writer/reader. Systems of the invention also include programming, e.g., in the form of computer program products, algorithms for use in practicing the methods as described above. Programming according to the present invention can be recorded on computer readable media, e.g., any medium that can be read and accessed directly by a computer. Such media include, but are not limited to: magnetic storage media, such as floppy discs, hard disc storage medium, and magnetic tape; optical storage media such as CD-ROM; electrical storage media such as RAM and ROM; portable flash drive; and hybrids of these categories such as magnetic/optical storage media.

The processor may also have access to a communication channel to communicate with a user at a remote location. By remote location is meant the user is not directly in contact with the system and relays input information to an input manager from an external device, such as a computer connected to a Wide Area Network (“WAN”), telephone network, satellite network, or any other suitable communication channel, including a mobile telephone (i.e., smartphone).

In some embodiments, systems according to the present disclosure may be configured to include a communication interface. In some embodiments, the communication interface includes a receiver and/or transmitter for communicating with a network and/or another device. The communication interface can be configured for wired or wireless communication, including, but not limited to, radio frequency (RF) communication (e.g., Radio-Frequency Identification (RFID), Zigbee communication protocols, WiFi, infrared, wireless Universal Serial Bus (USB), Ultra Wide Band (UWB), Bluetooth® communication protocols, and cellular communication, such as code division multiple access (CDMA) or Global System for Mobile communications (GSM).

In one embodiment, the communication interface is configured to include one or more communication ports, e.g., physical ports or interfaces such as a USB port, an RS-232 port, or any other suitable electrical connection port to allow data communication between the subject systems and other external devices such as a computer terminal (for example, at a physician's office or in hospital environment) that is configured for similar complementary data communication.

In one embodiment, the communication interface is configured for infrared communication, Bluetooth® communication, or any other suitable wireless communication protocol to enable the subject systems to communicate with other devices such as computer terminals and/or networks, communication enabled mobile telephones, personal digital assistants, or any other communication devices which the user may use in conjunction.

In one embodiment, the communication interface is configured to provide a connection for data transfer utilizing Internet Protocol (IP) through a cell phone network, Short Message Service (SMS), wireless connection to a personal computer (PC) on a Local Area Network (LAN) which is connected to the internet, or WiFi connection to the internet at a WiFi hotspot.

In one embodiment, the subject systems are configured to wirelessly communicate with a server device via the communication interface, e.g., using a common standard such as 802.11 or Bluetooth® RF protocol, or an IrDA infrared protocol. The server device may be another portable device, such as a smart phone, Personal Digital Assistant (PDA) or notebook computer; or a larger device such as a desktop computer, appliance, etc. In some embodiments, the server device has a display, such as a liquid crystal display (LCD), as well as an input device, such as buttons, a keyboard, mouse or touch-screen.

In some embodiments, the communication interface is configured to automatically or semi-automatically communicate data stored in the subject systems, e.g., in an optional data storage unit, with a network or server device using one or more of the communication protocols and/or mechanisms described above.

Output controllers may include controllers for any of a variety of known display devices for presenting information to a user, whether a human or a machine, whether local or remote. If one of the display devices provides visual information, this information typically may be logically and/or physically organized as an array of picture elements. A graphical user interface (GUI) controller may include any of a variety of known or future software programs for providing graphical input and output interfaces between the system and a user, and for processing user inputs. The functional elements of the computer may communicate with each other via system bus. Some of these communications may be accomplished in alternative embodiments using network or other types of remote communications. The output manager may also provide information generated by the processing module to a user at a remote location, e.g., over the Internet, phone or satellite network, in accordance with known techniques. The presentation of data by the output manager may be implemented in accordance with a variety of known techniques. As some examples, data may include SQL, HTML or XML documents, email or other files, or data in other forms. The data may include Internet URL addresses so that a user may retrieve additional SQL, HTML, XML, or other documents or data from remote sources. The one or more platforms present in the subject systems may be any type of known computer platform or a type to be developed in the future, although they typically will be of a class of computer commonly referred to as servers. However, they may also be a main-frame computer, a workstation, or other computer type. They may be connected via any known or future type of cabling or other communication system including wireless systems, either networked or otherwise. They may be co-located or they may be physically separated. Various operating systems may be employed on any of the computer platforms, possibly depending on the type and/or make of computer platform chosen. Appropriate operating systems include Windows, iOS, Oracle Solaris, Linux, IBM i, Unix, and others.

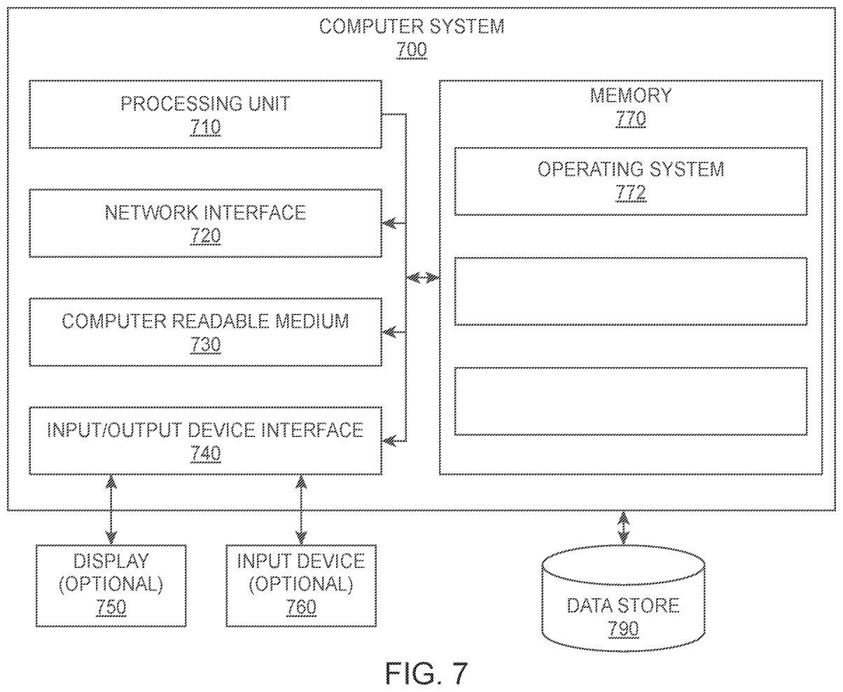

FIG. 7 depicts a general architecture of an example computing device 700 according to certain embodiments. The general architecture of the computing device 700 depicted in FIG. 7 includes an arrangement of computer hardware and software components. The computing device 700 may include many more (or fewer) elements than those shown in FIG. 7. It is not necessary, however, that all of these generally conventional elements be shown in order to provide an enabling disclosure. As illustrated, the computing device 700 includes a processing unit 710, a network interface 720, a computer readable medium drive 730, an input/output device interface 740, a display 750, and an input device 760, all of which may communicate with one another by way of a communication bus. The network interface 720 may provide connectivity to one or more networks or computing systems. The processing unit 710 may thus receive information and instructions from other computing systems or services via a network. The processing unit 710 may also communicate to and from memory 770 and further provide output information for an optional display 750 via the input/output device interface 740. The input/output device interface 740 may also accept input from the optional input device 760, such as a keyboard, mouse, digital pen, microphone, touch screen, gesture recognition system, voice recognition system, gamepad, accelerometer, gyroscope, or other input device.

The memory 770 may contain computer program instructions (grouped as modules or components in some embodiments) that the processing unit 710 executes in order to implement one or more embodiments. The memory 770 generally includes RAM, ROM and/or other persistent, auxiliary or non-transitory computer-readable media. The memory 770 may store an operating system 772 that provides computer program instructions for use by the processing unit 710 in the general administration and operation of the computing device 700. The memory 770 may further include computer program instructions and other information for implementing aspects of the present disclosure.

### Non-Transitory Computer-Readable Storage Medium

Aspects of the present disclosure further include non-transitory computer readable storage mediums having instructions for practicing the subject methods. Computer readable storage mediums may be employed on one or more computers for complete automation or partial automation of a system for practicing methods described herein. In certain embodiments, instructions in accordance with the method described herein can be coded onto a computer-readable medium in the form of “programming”, where the term “computer readable medium” as used herein refers to any non-transitory storage medium that participates in providing instructions and data to a computer for execution and processing. Examples of suitable non-transitory storage media include a floppy disk, hard disk, optical disk, magneto-optical disk, CD-ROM, CD-R magnetic tape, non-volatile memory card, ROM, DVD-ROM, Blue-ray disk, solid state disk, and network attached storage (NAS), whether or not such devices are internal or external to the computer. A file containing information can be “stored” on computer readable medium, where “storing” means recording information such that it is accessible and retrievable at a later date by a computer. The computer-implemented method described herein can be executed using programming that can be written in one or more of any number of computer programming languages. Such languages include, for example, Python, Java, Java Script, C, C#, C++, Go, R Swift, PHP, as well as any many others.

In some embodiments, the non-transitory computer readable storage medium includes algorithm for detecting light from a particle of a sample in a flow stream irradiated with a light source, algorithm for generating an image of each particle based on the detected light and algorithm for automatically adjusting a data acquisition parameter of the particle analyzer in response to a modulated visualization parameter for the image of the particle.

In some embodiments, the non-transitory computer readable storage medium includes algorithm for generating an image of a particle, such as one or more frequency-encoded images of the particle based on data signals from the light detection system. In some instances, the non-transitory computer readable storage medium includes algorithm for generating the image of the particle based on data signals from scattered light detector channels (e.g., forward scatter image data, side scatter image data). In other instances, the non-transitory computer readable storage medium includes algorithm for generating the image of the particle based on data signals from one or more fluorescence detector channels. In other instances, the non-transitory computer readable storage medium includes algorithm for generating the image of the particle based on data signals from one or more light loss detector channels. In still other instances, the non-transitory computer readable storage medium includes algorithm for generating the image of the particle based on data signals from a combination of data signals from two or more of light scatter detector channels, fluorescence detector channels and light loss detector channels.

In some instances, the non-transitory computer readable storage medium includes algorithm for modulating a visualization parameter of the image. In some instances, the non-transitory computer readable storage medium includes algorithm for modulating the visualization parameter for a region of analysis of the image. In some instances, the non-transitory computer readable storage medium includes algorithm for modulating a visualization threshold for the particle in the image. In certain instances, the non-transitory computer readable storage medium includes algorithm for modulating the visualization parameter in the region of analysis sufficient to visualize a border of the particle in the image. In some embodiments, the non-transitory computer readable storage medium includes algorithm for modulating visualization parameters of two or more particle images are modulated simultaneously.

In some instances, the non-transitory computer readable storage medium includes algorithm for modulating a pixel intensity threshold. In certain instances, the non-transitory computer readable storage medium includes algorithm for modulating the pixel intensity threshold for one or more detector channels. In some embodiments, the non-transitory computer readable storage medium includes algorithm for modulating the pixel intensity threshold for a scattered light detector channel (e.g., side-scatter or forward-scatter) and a fluorescence light detector channel. In other instances, the non-transitory computer readable storage medium includes algorithm for modulating the pixel intensity threshold for a scattered light detector channel and two or more fluorescence light detector channel. In certain instances, the detection parameter is a threshold for light intensity at each pixel location in the region of analysis. In some instances, the non-transitory computer readable storage medium includes algorithm for modulating the pixel intensity threshold for a scattered light detector channel (e.g., side-scatter or forward-scatter) and a fluorescence light detector channel. In certain instances, the non-transitory computer readable storage medium includes algorithm for modulating a pixel intensity threshold for a forward scattered light detector channel and a fluorescence light detector channel. In certain instances, the non-transitory computer readable storage medium includes algorithm for modulating a pixel intensity threshold for a side scattered light detector channel and a fluorescence light detector channel.

In certain embodiments, the non-transitory computer readable storage medium includes algorithm for modulating a visualization parameter when the pixel intensity in two or more detector channels exceeds or does not exceed a predetermined threshold according to a logic selected from:

| | | | |
|---|---|---|---|
| A and B | A or B | A and NOT B | NOT A and B |
| NOT A and NOT | NOT A or B | A or NOT B | A xor B |
| B | | | |
| NOT A or NOT | NOT A xor B | A xor NOT B | NOT A xor NOT |
| B | | | B |

where A and B are independently selected from a forward-scattered light detector channel (FSC); a side-scattered light detector channel (SSC); a fluorescence light detector channel (FL); and a light-loss detector channel (LL). In embodiments, the non-transitory computer readable storage medium includes algorithm for automatically adjusting a data acquisition parameter in response to a change in the visualization parameter for the particle image. In some embodiments, the non-transitory computer readable storage medium includes algorithm for automatically adjusting data acquisition parameters of the particle analyzer while light from the irradiated sample in the flow stream is being detected. In some instances, the non-transitory computer readable storage medium includes algorithm for dynamically adjusting a light intensity detection threshold for one or more of the detector channels in real time in response to a change in the visualization parameter. In some embodiments, the non-transitory computer readable storage medium includes algorithm for applying the change to the data acquisition parameter to data signals generated in one or more non-imaging photodetector channels of the light detection system.

In some embodiments, the data acquisition parameter is a light intensity detection threshold for generating an image. In some instances, the non-transitory computer readable storage medium includes algorithm for generating an image of the particle when light detected in one or more of the detection channels exceeds the adjusted light intensity detection threshold. In other instances, the non-transitory computer readable storage medium includes algorithm for not generating an image of the particle when light detected in a light detection channel does not exceed the light intensity threshold. In some instances, the non-transitory computer readable storage medium includes algorithm for automatically adjusting a sorting parameter for the particle analyzer in response to a change in the visualization parameter. In certain instances, the non-transitory computer readable storage medium includes algorithm for dynamically adjusting in real time a sorting gate for one or more particle populations in the sample in response to a change in a visualization parameter for a particle image.

The non-transitory computer readable storage medium may be employed on one or more computer systems having a display and operator input device. Operator input devices may, for example, be a keyboard, mouse, or the like. The processing module includes a processor which has access to a memory having instructions stored thereon for performing the steps of the subject methods. The processing module may include an operating system, a graphical user interface (GUI) controller, a system memory, memory storage devices, and input-output controllers, cache memory, a data backup unit, and many other devices. The processor may be a commercially available processor or it may be one of other processors that are or will become available. The processor executes the operating system and the operating system interfaces with firmware and hardware in a well-known manner, and facilitates the processor in coordinating and executing the functions of various computer programs that may be written in a variety of programming languages, such as those mentioned above, other high level or low level languages, as well as combinations thereof, as is known in the art. The operating system, typically in cooperation with the processor, coordinates and executes functions of the other components of the computer. The operating system also provides scheduling, input-output control, file and data management, memory management, and communication control and related services, all in accordance with known techniques.

### Kits

Aspects of the present disclosure further include kits, where kits include one or more of the components of light detection systems described herein. In some embodiments, kits include a plurality of photodetectors and programming for the subject systems, such as in the form of a computer readable medium (e.g., flash drive, USB storage, compact disk, DVD, Blu-ray disk, etc.) or instructions for downloading the programming from an internet web protocol or cloud server. Kits may also include an optical adjustment component, such as lenses, mirrors, filters, fiber optics, wavelength separators, pinholes, slits, collimating protocols and combinations thereof.

Kits may further include instructions for practicing the subject methods. These instructions may be present in the subject kits in a variety of forms, one or more of which may be present in the kit. One form in which these instructions may be present is as printed information on a suitable medium or substrate, e.g., a piece or pieces of paper on which the information is printed, in the packaging of the kit, in a package insert, and the like. Yet another form of these instructions is a computer readable medium, e.g., diskette, compact disk (CD), portable flash drive, and the like, on which the information has been recorded. Yet another form of these instructions that may be present is a website address which may be used via the internet to access the information at a removed site.

### Utility

The subject methods, systems and computer systems find use in a variety of applications where it is desirable to optimize the photodetectors of a light detection system. The subject methods and systems also find use for light detection systems having a plurality of photodetectors that are used to analyze and sort particle components in a sample in a fluid medium, such as a biological sample. The present disclosure also finds use in flow cytometry where it is desirable to provide a flow cytometer with improved cell sorting accuracy, enhanced particle collection, reduced energy consumption, particle charging efficiency, more accurate particle charging and enhanced particle deflection during cell sorting. In embodiments, the present disclosure reduces the need for user input or manual adjustment during sample analysis with a flow cytometer. In certain embodiments, the subject methods and systems provide fully automated protocols so that adjustments to a flow cytometer during use require little, if any human input.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. Moreover, nothing disclosed herein is intended to be dedicated to the public regardless of whether such disclosure is explicitly recited in the claims.

The scope of the present invention, therefore, is not intended to be limited to the exemplary embodiments shown and described herein. Rather, the scope and spirit of present invention is embodied by the appended claims. In the claims, 35 U.S.C. § 112(f) or 35 U.S.C. § 112(6) is expressly defined as being invoked for a limitation in the claim only when the exact phrase “means for” or the exact phrase “step for” is recited at the beginning of such limitation in the claim; if such exact phrase is not used in a limitation in the claim, then 35 U.S.C. § 112 (f) or 35 U.S.C. § 112(6) is not invoked.

1. A particle analyzer comprising:
a light detection system comprising an imaging photodetector, wherein the light detection system is configured to detect light from particles of a sample in a flow stream irradiated with a light source; and
a processor comprising memory operably coupled to the processor wherein the memory comprises instructions stored thereon, which when executed by the processor, cause the processor to:
generate an image of each particle based on the detected light;
modulate a visualization parameter for the image of a particle in the flow stream; and
automatically adjust a data acquisition parameter of the particle analyzer in response to the modulated visualization parameter.

2. The particle analyzer according to claim 1, wherein the memory comprises instructions to generate the image of the particle from data signals from a side-scattered light detector channel of the light detection system.

3. The particle analyzer according to claim 1, wherein the memory comprises instructions to generate the image of the particle from data signals from one or more fluorescence detector channels of the light detection system.

4. The particle analyzer according to claim 1, wherein the memory comprises instructions to generate the image of the particle from data signals from a forward-scattered light detector channel of the light detection system.

5. The particle analyzer according to claim 1, wherein the memory comprises instructions to generate the image of the particle from data signals from a light loss detector channel of the light detection system.

6. The particle analyzer according to claim 1, wherein the memory comprises instructions to modulate the visualization parameter for a region of analysis of the image.

7. The particle analyzer according to claim 6, wherein the memory comprises instructions to modulate the visualization parameter to exceed a threshold visualization of the particle in the region of analysis.

8. The particle analyzer according to claim 7, wherein the memory comprises instructions to modulate the visualization parameter sufficient to visualize a border of the particle in the image.

9-10. (canceled)

11. The particle analyzer according to claim 1, wherein the visualization parameter is a pixel intensity threshold.

12. The particle analyzer according to claim 11, wherein the memory comprises instructions to modulate the pixel intensity threshold for one or more locations in the region of analysis.

13-19. (canceled)

20. The particle analyzer according to claim 11, wherein the memory comprises instructions to modulate the visualization parameter when the pixel intensity in two or more detector channels exceeds or does not exceed a predetermined threshold according to a logic selected from the group consisting of:

| | | | |
|---|---|---|---|
| A and B | A or B | A and NOT B | NOT A and B |
| NOT A and NOT | NOT A or B | A or NOT B | A xor B |
| B | | | |
| NOT A or NOT | NOT A xor B | A xor NOT B | NOT A xor NOT |
| B | | | B |

wherein A and B are independently selected from a forward-scattered light detector channel (FSC); a side-scattered light detector channel (SSC); a fluorescence light detector channel (FL); and a light-loss detector channel (LL).

21. The particle analyzer according to claim 11, wherein the pixel intensity threshold comprises an image mask threshold.

22. The particle analyzer according to claim 11, wherein the particle analyzer further comprises a display comprising a graphical user interface (GUI) for modulating the visualization parameter of the particle image.

23. The particle analyzer according to claim 22, wherein the GUI comprises a slide bar for adjusting the pixel intensity threshold.

24-26. (canceled)

27. The particle analyzer according to claim 1, wherein the memory comprises instructions to automatically adjust a light intensity detection threshold for one or more of the detector channels of the particle analyzer in response to a change in the visualization parameter for the particle image.

28. The particle analyzer according to claim 27, wherein the memory comprises instructions to generate an image of the particle when light detected by the side scattered light detection channel exceeds the adjusted light intensity detection threshold.

29. The particle analyzer according to claim 27, wherein the memory comprises instructions to not generate an image of the particle when light detected by the side scattered light detection channel does not exceeds the adjusted light intensity detection threshold.

30. The particle analyzer according to claim 1, further comprises a particle sorter.

31. The particle analyzer according to claim 30, wherein the memory comprises instructions to automatically generate a sorting gate for particles of the sample in response to the adjusted visualization parameter.

32. The particle analyzer according to claim 1, further comprising a light source for irradiating particles of the sample in the flow stream.

33-120. (canceled)
